(19) United States
(12) Patent Application Publication
(10) Pub. No.: US 2015/0217337 A1
(43) Pub. Date: Aug. 6, 2015

(54) VESSEL AND PUMPING APPARATUS FOR CLEANING A SCRUBBING ARTICLE

(71) Applicant: GLEAMFIRE LLC, Belmont, MA (US)

(72) Inventors: Suriyan John Lohavichan, Belmont, MA (US); Scott H. Wakefield, Andover, MA (US); Michael J. Flannery, Westford, MA (US); John M. Aho, Lunenburg, MA (US)

(21) Appl. No.: 14/610,601

(22) Filed: Jan. 30, 2015

Related U.S. Application Data
(63) Continuation-in-part of application No. 14/172,176, filed on Feb. 4, 2014.

(51) Int. Cl. B08B 3/06; A46B 17/06; A47L 25/00

(52) U.S. Cl. CPC B08B 3/06; A47L 25/00; A46B 17/06

(57) ABSTRACT

A scrubbing article cleaning device may include a hollow vessel capable of retaining liquid and having an open top, a pumping apparatus having a handle connected to a top end of a pole portion, wherein said pole portion includes at least one segment of perforated pipe, and a plunger assembly connected to said pole portion, wherein said plunger assembly may include one or more perforated disks and one or more filter media.

### CROSS-REFERENCE TO RELATED APPLICATIONS

This application is a continuation-in-part of U.S. patent application Ser. No. 14/172,176, filed Feb. 4, 2014, titled VESSEL AND PUMPING APPARATUS CLEANING SYSTEM, which is incorporated by reference in its entirety for all purposes.

### BACKGROUND

Sponges, rags, wash mitts, and other scrubbing articles for washing vehicles often collect abrasive substances and particles such as sand and dirt during the cleaning of a vehicle. These substances can subsequently scratch the surface of the vehicle when the scrubbing article comes into contact with the vehicle.

When washing vehicles or other valuable objects, a bucket full of soapy water is often used to rinse off a scrubbing article, such as a sponge, rag, brush, or wash mitt. This also generally serves to reapply washing substances, such as soap, to the scrubbing article. However, dipping a scrubbing article in such a bucket may not adequately remove damaging substances and particles like sand and grit caught in a sponge. Even if damaging substances are removed from the scrubbing article, they may remain in the bucket, allowing for them to potentially re-collect in the scrubbing article on subsequent dips of the scrubbing article in the bucket. Furthermore, because the bucket is an enclosed vessel, the concentration of contaminants within the soapy water will only continue to increase as the user washes the vehicle surface.

One method of ameliorating the buildup of damaging substance is to wring the scrubbing article out, forcing excess water and some amount of dirt out of the scrubbing article in the process. However, this technique does not adequately remove the damaging substances present on the scrubbing article and may even exacerbate scratching of the vehicle surface by removing excess water. Also, the processes of wringing the scrubbing article out removes the excess soapy water, which is useful for cleaning the vehicle surface. This technique may also waste significant amounts of water if the scrubbing article is wrung out away from the bucket of soapy water.

### SUMMARY

In one exemplary embodiment, a scrubbing article cleaning device may be provided. The scrubbing article cleaning device may include a hollow vessel capable of retaining liquid and having an open top. The scrubbing article cleaning device may also include a pumping apparatus having a handle connected to a top end of a pole portion, wherein said pole portion includes at least one segment of perforated pipe. A plunger assembly may be connected to said pole portion, wherein said plunger assembly may include one or more perforated disks, which may be ribbed, and one or more filter media. The plunger assembly may also include one or more baffles which may also be perforated. The top of the hollow vessel may also include a funnel portion that is designed to releasably hold the handle portion of the pumping apparatus for easy carrying and/or storage. The scrubbing article cleaning device may also include a means for aligning the pole portion with the one or more perforated disks including, but not limited to, corresponding notches and/or grooves, corresponding holes for fasteners, a corresponding catch and lever on either of said pole portion and/or said perforated disks, or other fastener with corresponding components on either of said pole portion and/or said perforated disks.

In some embodiments, the pumping apparatus, may have a plunger comprising one or more filter media containing one or more cutouts and one or more perforated disks having a flanged portion for receiving said cutouts of said one or more filter media. The plunger assembly may also include one or more second perforated disks having an opening for cooperating with said flanged portion of the first perforated disk. The one or more filter media may be retained between said one or more first perforated disks and said one or more second perforated disks. The first or second perforated disks may also include one or more ribs or ridges and/or one or more notches around the edge or perimeter of said first or second perforated disks. The one or more first or second perforated disks may also include one or more brackets for receiving one or more baffles. The baffles may also be perforated in some embodiments.

In another exemplary embodiment, a process for manufacturing a scrubbing article cleaning device may be performed. The process may include mounting one or more filter media on a flanged portion of a first perforated disk; mounting a second perforated disk on the flanged portion of said first perforated disk such that the one or more filter media are located between said first and second perforated disks; inserting a perforated pole through the one or more filter media, the first perforated disk, and the second perforated disk; and attaching said perforated pole to at least one of said first or said second perforated disks.

### BRIEF DESCRIPTION OF DRAWINGS

Various aspects of at least one embodiment are discussed below with reference to the accompanying figures. Where technical features in the figures or detailed description are followed by reference signs, the reference signs have been included for the sole purpose of increasing the intelligibility of the figures and/or detailed description. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention. The figures also are not necessarily drawn to scale. In the figures:

FIG. 1 is a front elevation view of an exemplary embodiment of a scrubbing article cleaning device.

FIG. 2 is a cross-sectional view of an exemplary embodiment of a scrubbing article cleaning device.

FIG. 3 is a front elevation view of an exemplary embodiment of a scrubbing article cleaning device, with the pumping apparatus removed.

FIG. 4 is a perspective view of a funnel portion of an exemplary embodiment of a scrubbing article cleaning device.

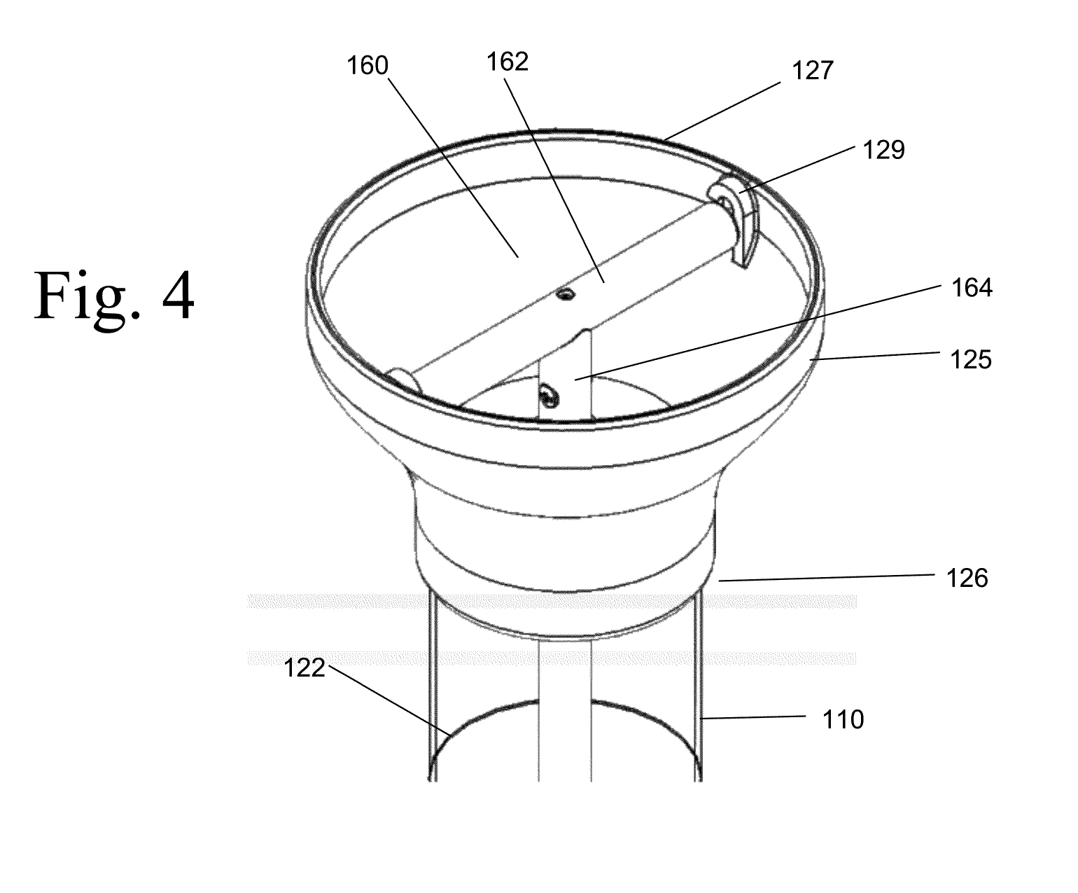

FIG. 5 is a cross-sectional view of a funnel portion and the base portion of an exemplary embodiment of a scrubbing article cleaning device.

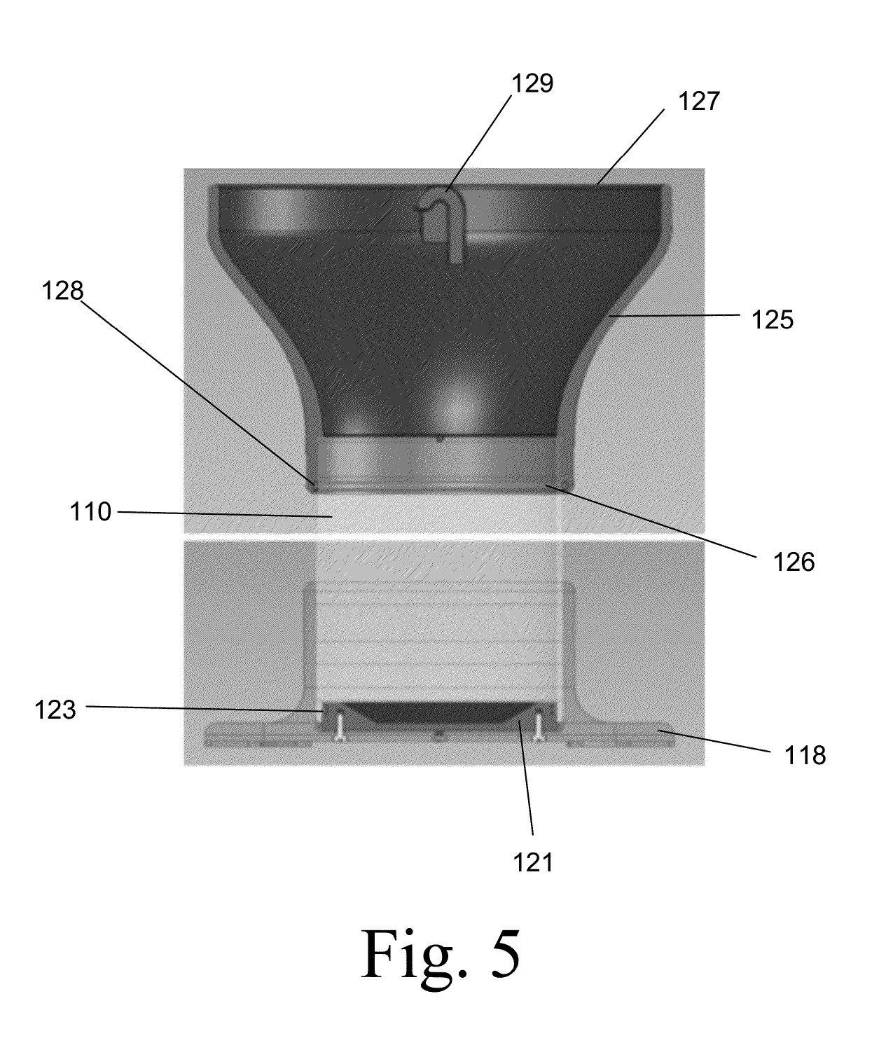

FIG. 6 is a frontal elevation view of the hollow vessel of an exemplary embodiment of a scrubbing article cleaning device with the pumping apparatus removed.

FIG. 7 is an exploded view of the hollow vessel of an exemplary embodiment of a scrubbing article cleaning device with the pumping apparatus removed.

FIG. 8 is a cross-sectional and exploded view of a funnel portion of an exemplary embodiment of a scrubbing article cleaning device.

FIG. 9 is a bottom perspective, partially exploded view of the hollow vessel of an exemplary embodiment of a scrubbing article cleaning device with the pumping apparatus removed.

FIG. 10 is a perspective view of the pumping apparatus of an exemplary embodiment of a scrubbing article cleaning device removed from the hollow vessel.

FIG. 11 is an exploded view of the pumping apparatus of an exemplary embodiment of a scrubbing article cleaning device.

FIG. 12 is a bottom perspective view of a pole portion of the pumping apparatus of an exemplary embodiment of a scrubbing article cleaning device.

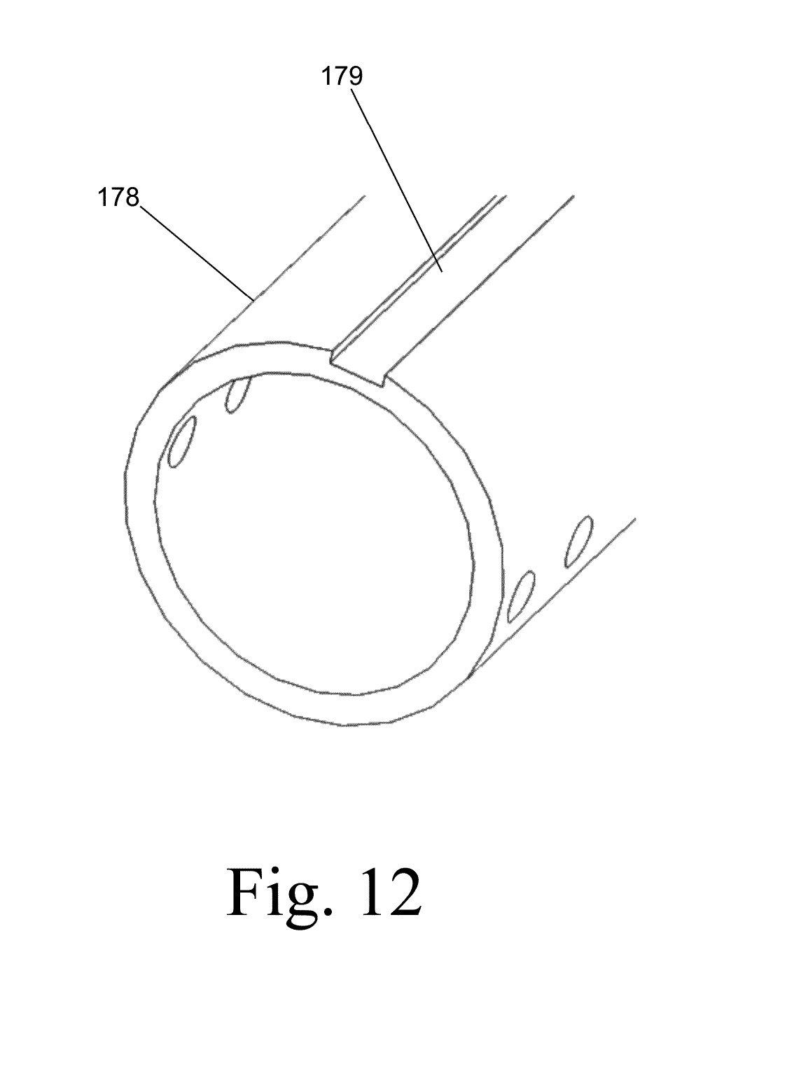

FIG. 13 is an exploded view of a pole portion and handle portion of an exemplary embodiment of a scrubbing article cleaning device.

FIG. 14 is an exploded view of the disks and baffle portions of the pumping apparatus of an exemplary embodiment of a scrubbing article cleaning device.

FIG. 15 is an exploded view of the filter housing portion of the pumping apparatus of an exemplary embodiment of a scrubbing article cleaning device.

FIG. 16 is an exploded view of the filter housing portion of the pumping apparatus of an exemplary embodiment of a scrubbing article cleaning device.

FIG. 17 is a front elevation view of an embodiment of a scrubbing article cleaning device in use.

FIG. 18 is a front elevation view of an embodiment of a scrubbing article cleaning device in use.

FIG. 19 is a front elevation view of an alternative embodiment of a scrubbing article cleaning device.

FIG. 20 is an exploded view of an alternative embodiment of a scrubbing article cleaning device.

FIG. 21 is a front elevation view of an alternative embodiment of a scrubbing article cleaning device in use.

FIG. 22 is a front elevation view of an alternative embodiment of a scrubbing article cleaning device in use.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments,” or “invention” do not require that all embodiments of the invention include the discussed feature, advantage or mode of operation.

Referring to the figures generally, a scrubbing article cleaning device may include a substantially hollow vessel 110 and a pumping apparatus 150 that may be inserted into the substantially hollow vessel 110. In an exemplary embodiment, substantially hollow vessel 110 may be a cylindrical tube. In an alternative embodiment, substantially hollow vessel 110 may be a rectangular tube. In yet other exemplary embodiments, hollow vessel 110 may be any shape as would reasonably be understood by a person having ordinary skill in the art to work in accordance with the following description. Hollow vessel 110 may have an open top end 112, a closed bottom end 114, and may be substantially elongated in a vertical direction. Hollow vessel 110 may also be able to retain water. In some embodiments, this may entail that hollow vessel 110 is made of water-tight material and that the seal of closed bottom end 114 is watertight.

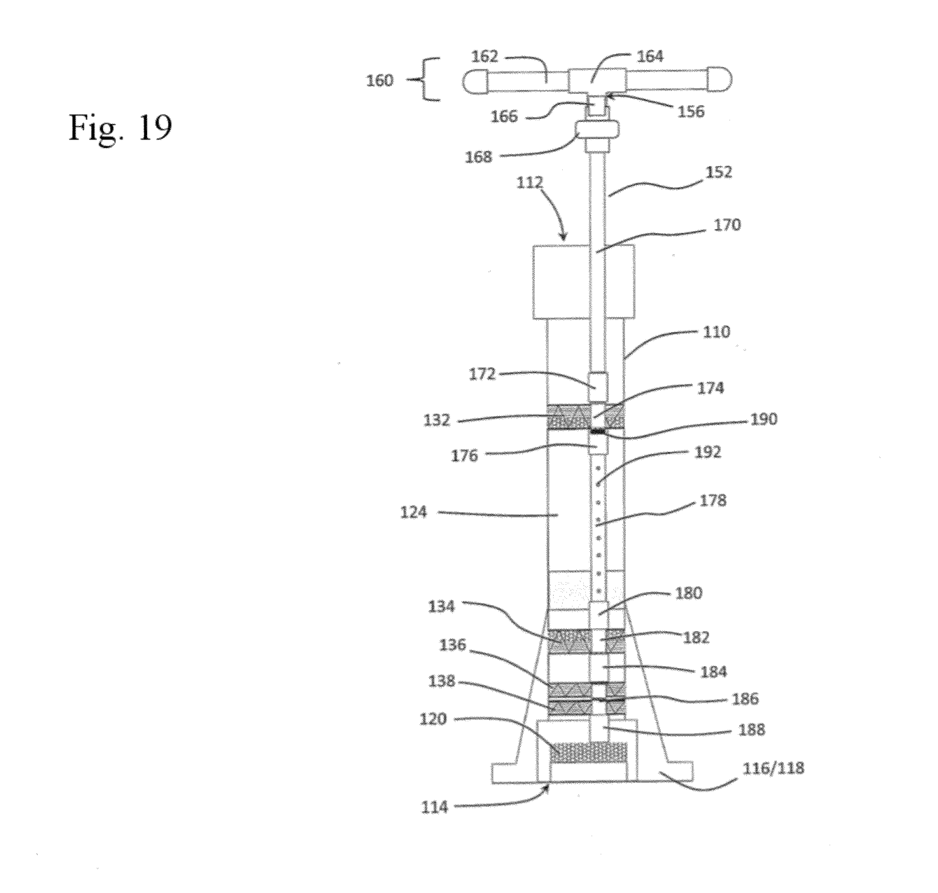

In some embodiments, water filtering may be performed by filter media located at the base of hollow vessel 110, as shown, for example, in FIG. 19. In these embodiments, hollow vessel 110 may have a cushion material disposed within its interior, proximate bottom end 114. This may provide a cushion for the bottom of the pumping apparatus 150 during use. It also may filter dirt particles and grit near the bottom of the vessel. In an exemplary embodiment, the cushion 120 may be a piece of dense filter foam. The filter foam cushion 120 may be approximately three inches to approximately five inches in diameter. More specifically, the filter foam cushion 120 may be approximately ten centimeters in diameter. The filter foam cushion 120 may have a depth of between approximately 0.5 inches and 4 inches. More specifically, the filter foam cushion 120 may have a depth of approximately 1 inch.

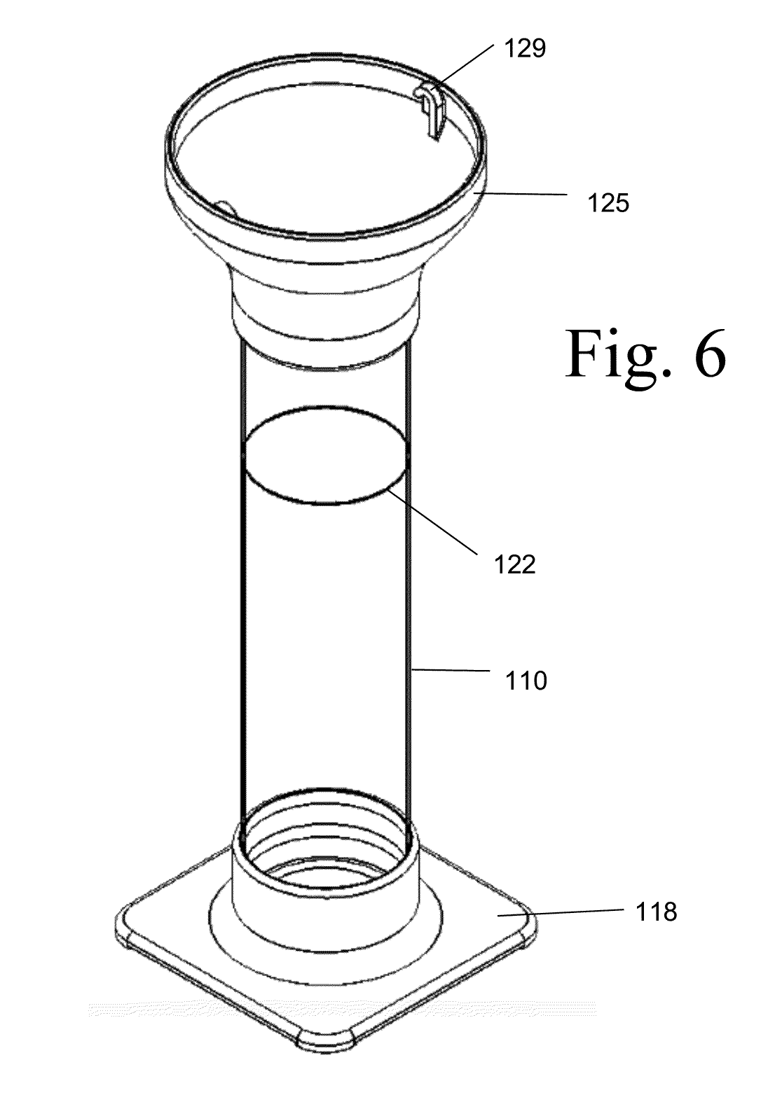

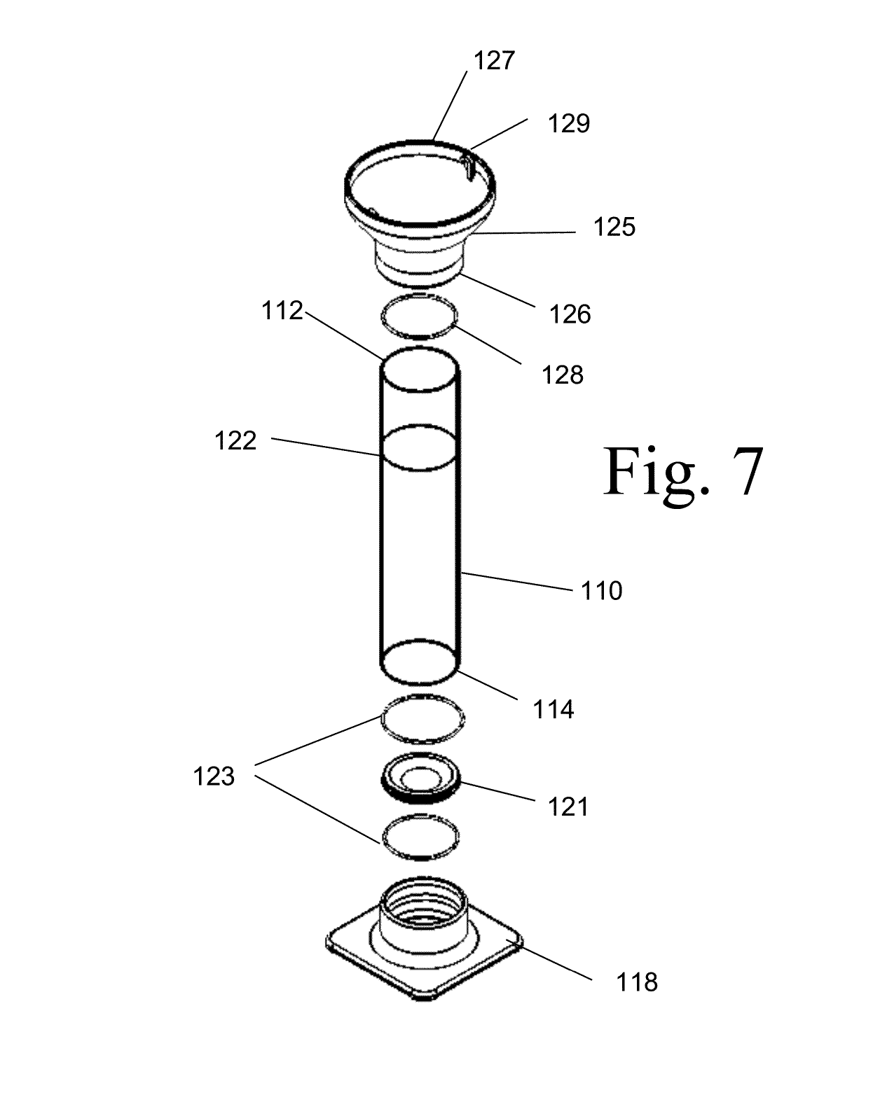

In other embodiments, no filtering is performed at the base of hollow vessel 110, as shown, for example, in FIGS. 6-7. In these embodiments, hollow vessel 110 may have a plug 121 that is dimensioned to matingly fit into bottom end 114 of hollow vessel 110 thereby forming a water-tight seal. Plug 121 may be formed of any suitable, water-impervious material. In some embodiments, plug 121 is formed of Acrylonitrile Butadiene Styrene (ABS) plastic. In some embodiments, one or more o-rings 123 may be inserted between hollow vessel 110 and plug 121 or between plug 121 and base 118, to ensure a water-tight fit that can withstand the elevated water pressure created by pumping apparatus 150.

In some exemplary embodiments, hollow vessel 110 may have a fill line 122 disposed on its surface to designate a fill level for water or a washing solution. The fill line 122 may be added by marker, paint or dye. In some embodiments, the fill line 122 is added using a resilient and adhesive black paint. Alternatively, the fill line 122 may be a strip of vinyl material attached to the interior of vessel 110. To secure the vinyl material, it may be attached with waterproof glue and further sealed with waterproof edge sealant. In yet other exemplary embodiments, fill line 122 may be created by any comparable method as would be reasonably understood by a person having ordinary skill in the art.

Hollow vessel 110 may be shaped to stand upright on its own or it may be designed with an integrated base portion or feet 116, or it may have a separate base or support 118 that may interact with it to hold it in a desired location and orientation. In one exemplary embodiment, integrated base portion or feet 116 may be foldable feet members. The foldable feet members may not only provide wider points of contact to prevent tipping, but in some embodiments, they may allow a user to stand on the feet members creating yet more stability. Alternatively, the integrated base portion or feet 116 may be rigidly mounted feet members. Rigidly deployed feet members may function similarly to the various embodiments of foldable feet members. There may be at least two feet members in embodiments with rigidly deployed or foldable feet members.

In yet other exemplary embodiments, the integrated base portion or feet 116 may be a section of material, such as a flange, disposed around the bottom of vessel 110 to create a larger contact area with the surface on which the device is located. The base portion or feet 116 may also add weight to the bottom of vessel 110 in some embodiments to increase the stability of the device. The weight may also prevent the vessel 110 from being lifted during operation.

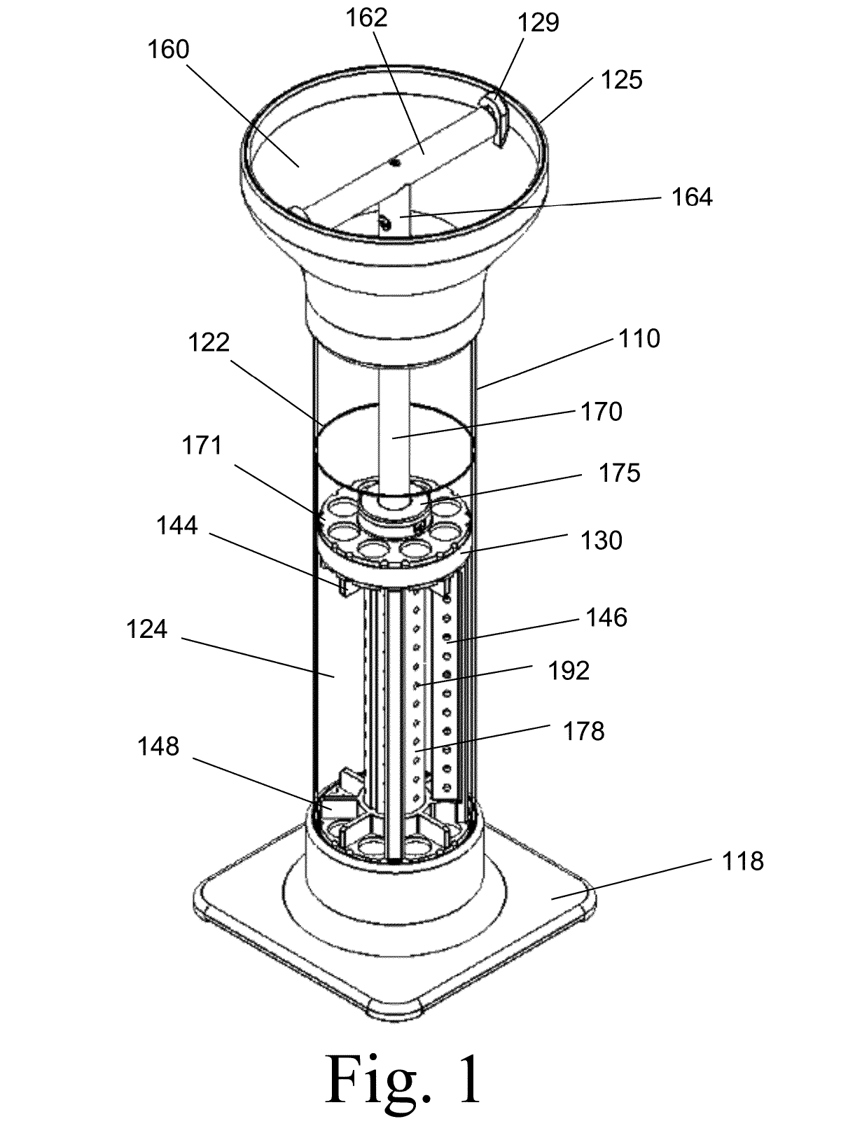

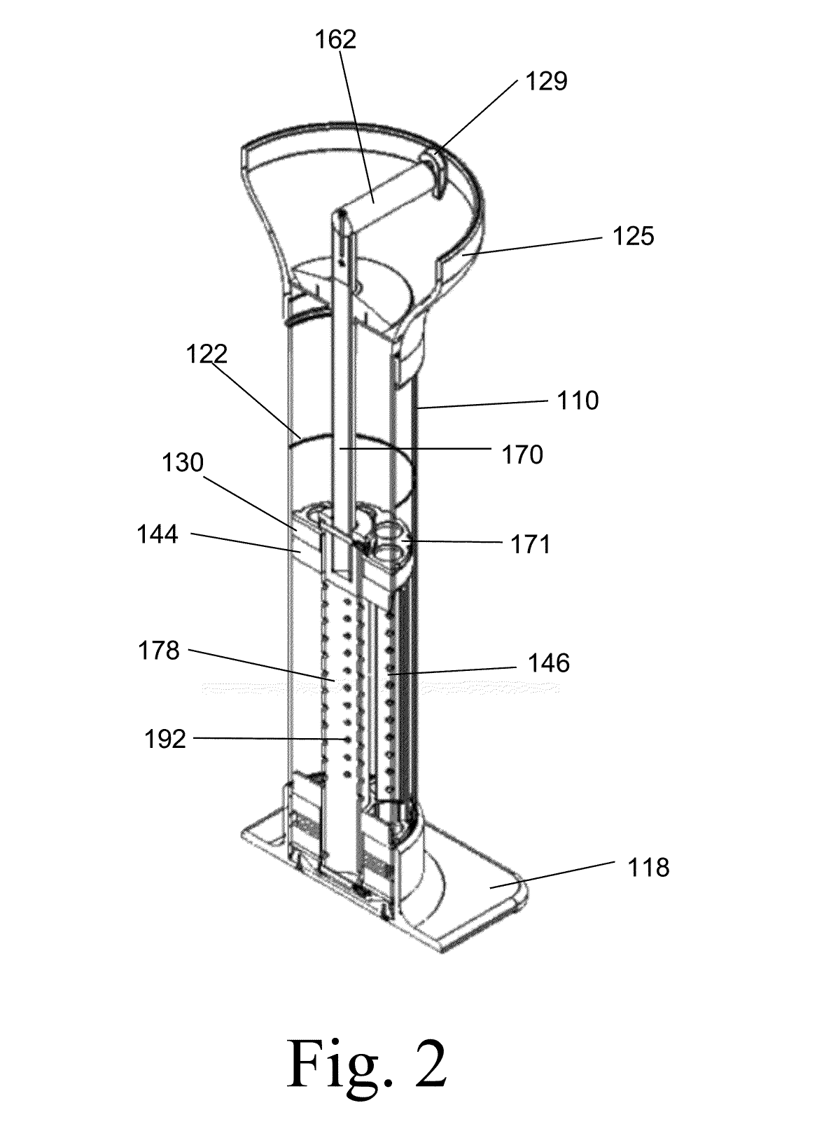

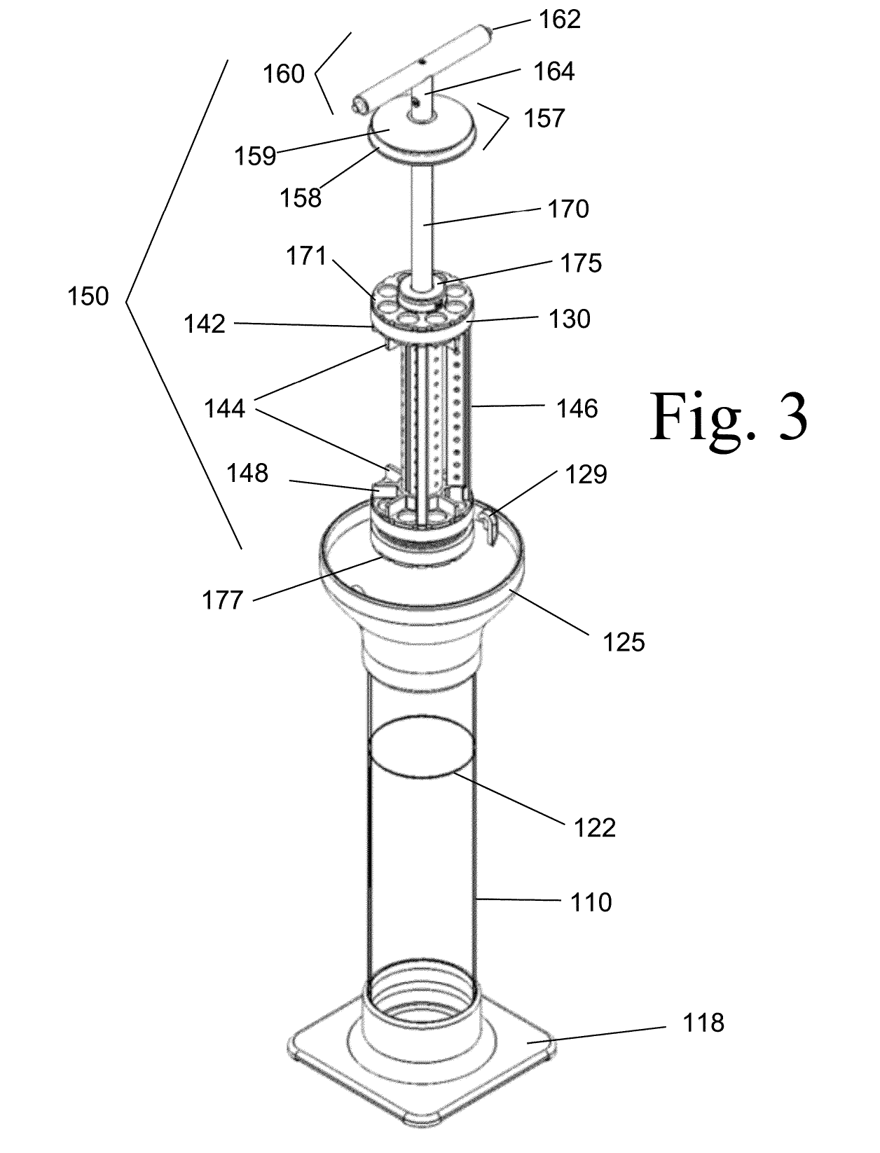

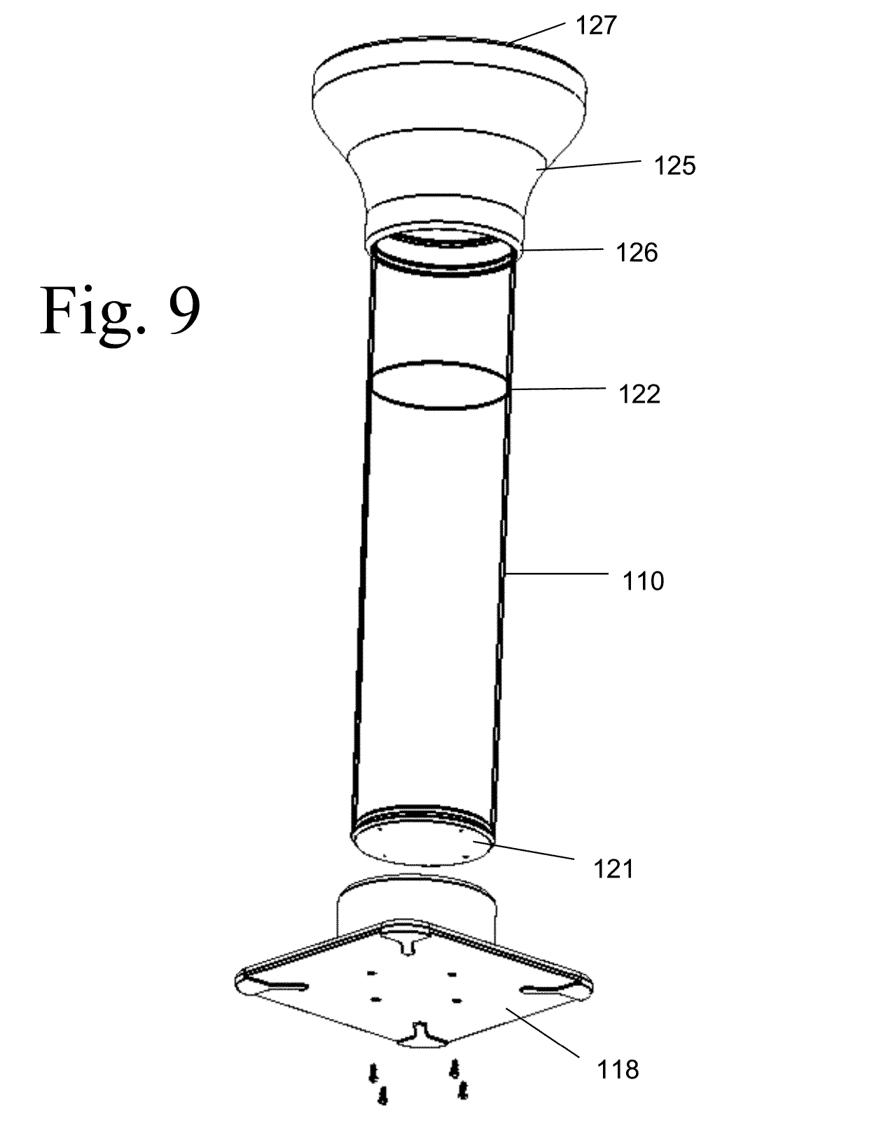

An exemplary embodiment having a separate base or support 118, could have a circular, square, or rectangular flange attached to bottom end 114 of hollow vessel 110, and covering plug 121, as shown, for example, in FIGS. 1-3, 7, and 9. In this exemplary arrangement, separate base or support 118 may be screwed into the underside of plug 121, as shown in FIG. 9, for example. Alternatively, separate base or support 118 may be connected to hollow vessel 110 and/or plug 121 using a friction fit, a locking mechanism, or any other suitable means of attachment as are known in the art.

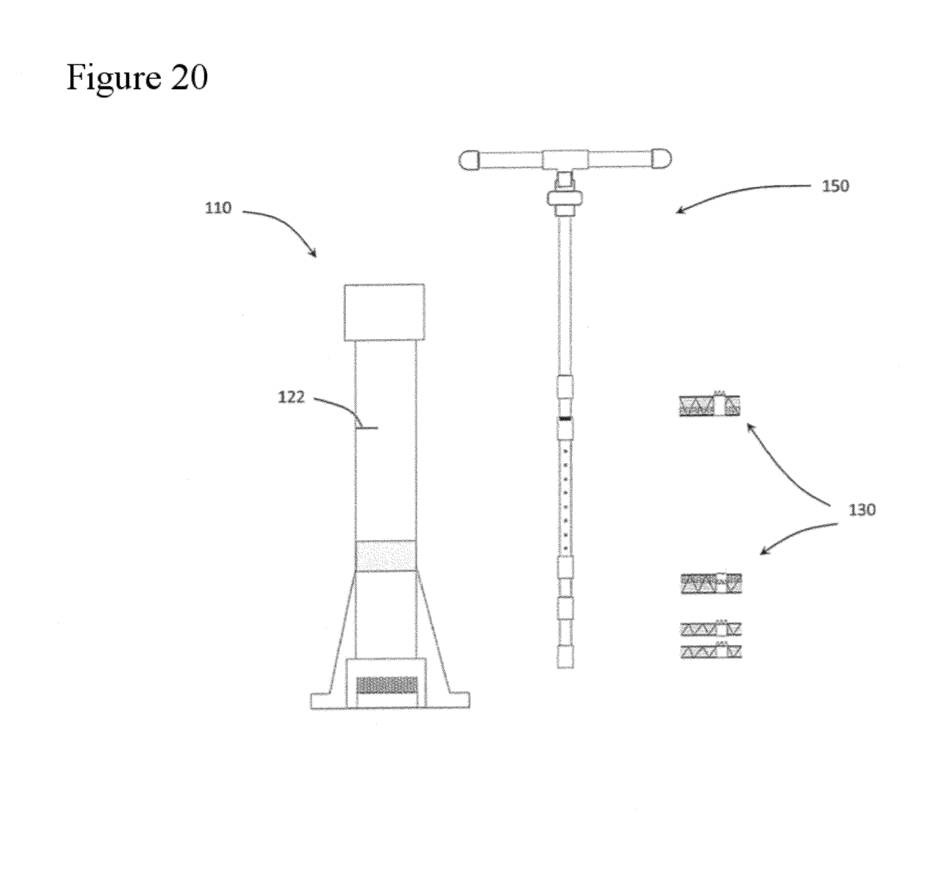

Another exemplary embodiment having a separate base or support 118 could have a cone or similar shaped object adapted to receive hollow vessel 110, as shown in FIGS. 19-22. An alternative embodiment could have a tripod or other support legs capable of receiving vessel 110. For embodiments having a separate base or support 118, the separate base or support 118 may function similarly to the base portion or feet 116 in that it may allow the vessel to stand upright, stabilize the vessel, and prevent the vessel from being lifted during operation.

An exemplary embodiment of hollow vessel 110 may be assembled of a clear, cast acrylic tube, as shown in FIGS. 1-3, 7, and 9. The outside diameter of the acrylic tube may vary from approximately 2 inches to approximately 24 inches and in some embodiments may be about 5½ inches. The acrylic tube may be approximately 12 to 36 inches in length. In some embodiments, the outside diameter of hollow vessel 110 is designed to match the inside diameter of a recessed portion of a separate base or support 118 so that it may receive hollow vessel 110 and hold it in place.

In another exemplary embodiment, hollow vessel 110 may be assembled of a four inch PVC coupling attached to one end of a four inch (diameter) PVC pipe, as shown in FIG. 19. However, the diameter of the pipe may vary from approximately 2 inches to approximately 24 inches. The PVC pipe may be approximately 12 to 36 inches in length. The connection between the PVC coupling and the PVC pipe may be sealed by using a waterproof silicone sealant or a PVC solvent weld. The PVC coupling end may serve as the top, open end of the vessel. A PVC threaded end cap may be joined to the end of the vessel opposite the PVC coupling. This may be threaded and sealed to the PVC pipe, creating a waterproof bottom end 114. A rubber traffic cone, which has been cut down to approximately 10 inches in height by removing a top portion of the cone, may be used as a base. The PVC pipe may be inserted into the cone and the cone may be secured to the outside of the PVC pipe with a metal pipe coupling band. The cone may be secured to the pipe so that the bottom of the cone is approximately even with the bottom of the PVC pipe, allowing the cone to function as a base support.

In some embodiments, a funnel or flute 125 is connected at open top end 112 of hollow vessel 110, as shown, for example, in FIG. 6. The inside diameter of funnel or flute 125 generally increases from its proximal end 126, where it is connected to open top end 112 of hollow vessel 110, to its distal end 127, which is open. At its proximal end 126, the internal diameter of funnel or flute 125 matches the outside diameter of hollow vessel 110, which may vary from approximately 2 inches to approximately 24 inches and in some embodiments may be about 5¼ inches. At its distal end 127 funnel or flute 125 may be 1.5 to 3 times the diameter of hollow vessel 110. Thus, the inside diameter of distal end 127 may vary from 3 inches to 72 inches and in some embodiments may be about 10½ inches wide. The wider distal end 127 allows the funnel or flute 125 to recapture excess water that sometimes drips from the scrubbing article upon removal from the device. In some embodiments, the internal diameter of distal end 127 matches the length of cross member 162 of handle portion 160, which is described below. This allows the pumping apparatus 150 to be conveniently stored within hollow vessel 110 during periods of non-use. Funnel or flute 125 may be formed of any suitable material, such as an acetal, polypropylene, high density polyethylene (HDPE), polycarbonate, acrylonitrile butadiene sStyrene (ABS), polycarbonate/ABS alloy, polybutylene terephthalate, polybutylene, and polyethylene terephthalate, glass-filled acrylic and/or non-corrosive metal.

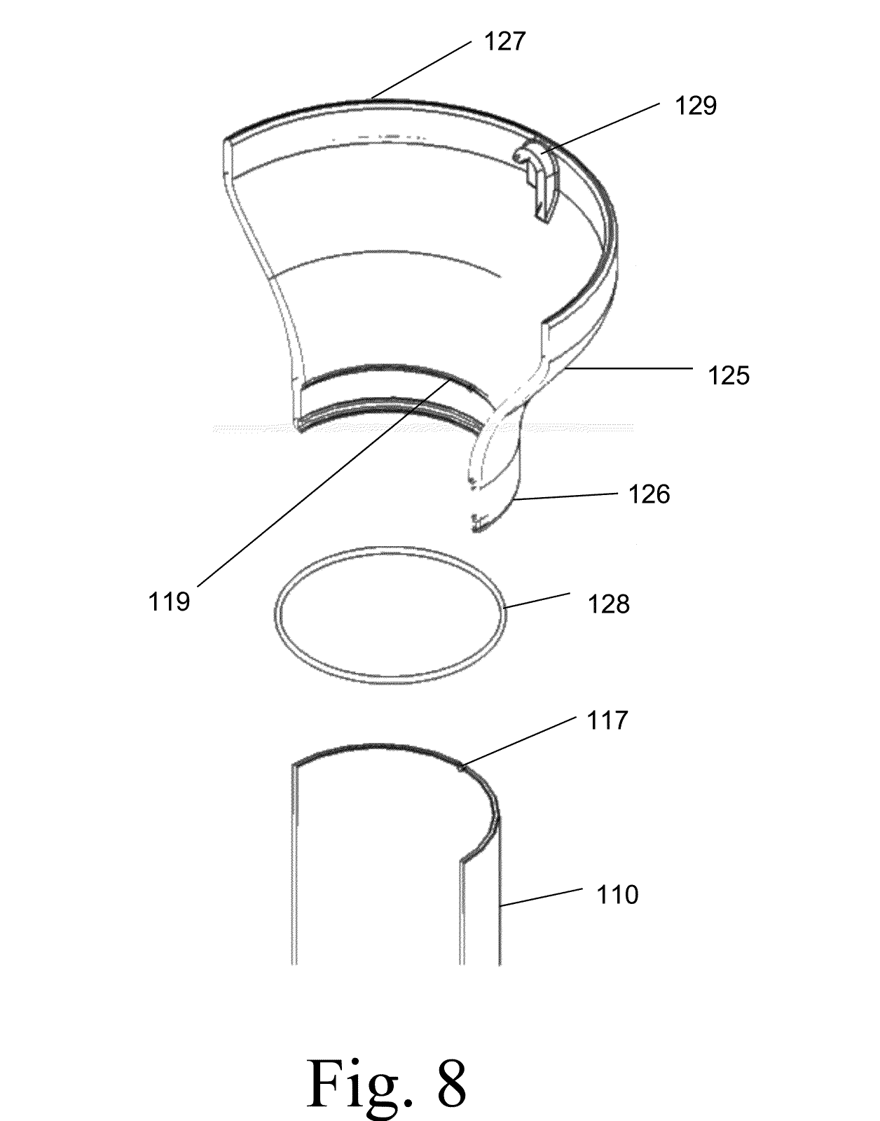

Funnel or flute 125 may be connected to hollow vessel 110 using any suitable means of attachment known to those of skill in the art. In some embodiments, funnel or flute 125 may be attached by screwing it into open top 112 of hollow vessel 110 or it may be fastened using adhesives, soldering, welding, using a fastener such as a bolt, or by using a locking mechanism. In some embodiments, funnel or flute 125 may be connected to hollow vessel 110 by inserting open top 112 into proximal end 126, the internal diameter of which may be sized to match the outside diameter of hollow vessel 110 so as to form a close fit. In some embodiments, proximal end 126 is specifically formed to matingly couple with open top 112, as shown, for example, in FIG. 8. For example, the proximal end of funnel or flute 125 may be formed with an internal lip for receiving and abutting open top 112. The proximal end of funnel or flute 125 may also be formed to allow it to receive adhesives in a recessed portion that may span a region surrounding the interior of proximal end 126. An o-ring 128 may also be inserted in another recessed portion between funnel or flute 125 and hollow vessel 110 in order to maintain a seal when pumping apparatus 150 is actuated.

Open top 112 and proximal end 126 may also be formed with a keying feature in order to ensure that the funnel or flute 125 and hollow vessel 110 align properly during coupling. The keying feature may employ any suitable means for forcing hollow vessel 110 and funnel or flute 125 to properly align. In some embodiments, the proximal end 126 may be formed with one or more protrusions 119 on the interior of the funnel or flute 125, which corresponds to one or more notches 117 that may be formed at the top of open top 112. During coupling, the one or more protrusions 119 may fit within the one or more notches 117, ensuring that the hollow vessel 110 is properly aligned with the funnel or flute 125.

In some embodiments, funnel or flute 125 also contains a means for locking the pumping apparatus 150 in place in the downward (plunged) position during periods of non-use. In some arrangements, the means for locking the pumping apparatus 150 may comprise a locking mechanism such as one or more slots or a partial ring 129 that is integrally formed within the interior of funnel or flute 125 near the distal end 127, as shown in FIG. 6. Other locking means may be used, as are known to those of skill in the art, and the locking means need not be integrally formed within the interior of funnel or flute 125. The locking means may be attached to funnel or flute 125 using any suitable means of attachment, as known to those of ordinary skill In some embodiments, at least one slot or partial ring 129 is placed on the interior of funnel or flute 125 near the distal end 127, as shown, for example, in FIG. 6, so that one or more ends of cross member 162 of handle portion 160 may fit into the at least one slot or partial ring 129. If two or more slots or partial rings 129 are employed, the opening in the slots should face alternate directions to allow the ends of cross member 162 to be lowered and twisted into place. The at least one slot or partial ring 129 may be placed sufficiently low within the interior of funnel or flute 125 such that the internal diameter of funnel or flute 125 at that point is marginally less than the length of cross member 162. This may ensure a snug fit between the at least one slot or partial ring 129, the ends of cross member 162, and the interior wall of funnel or flute 125.

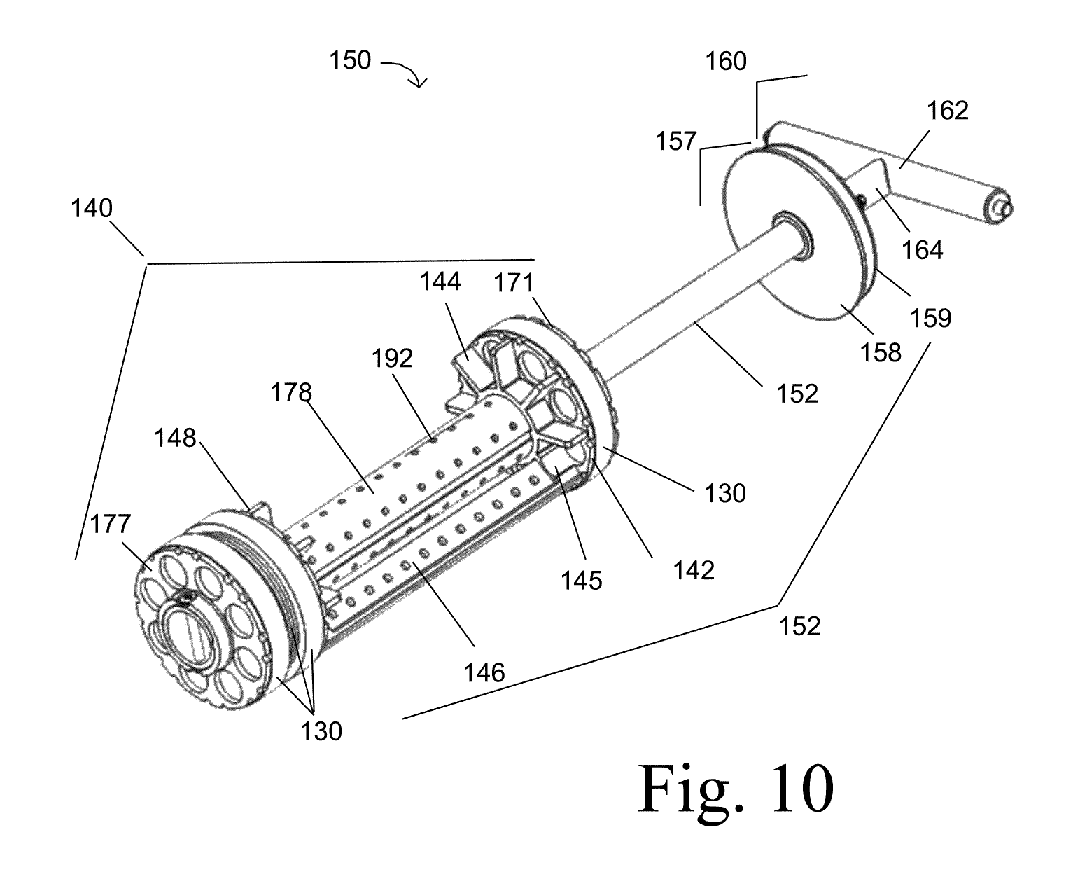

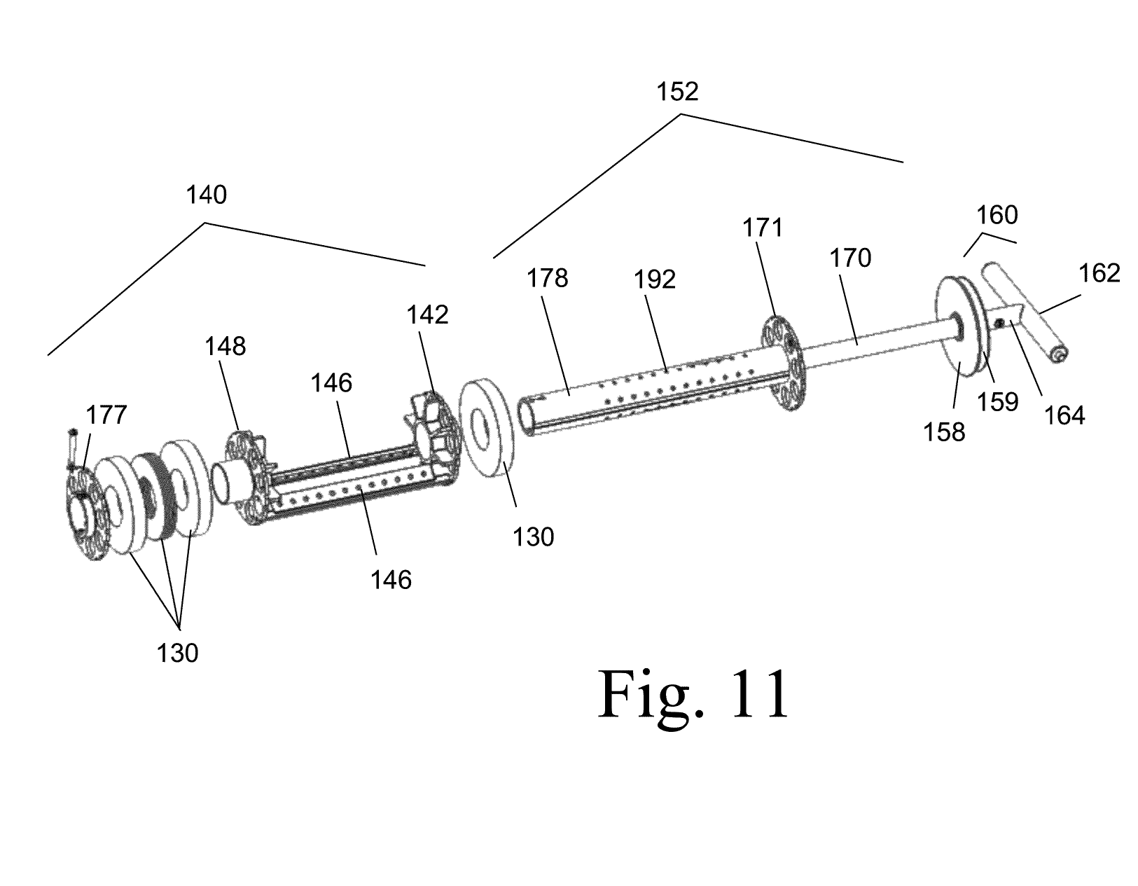

Pumping apparatus 150 is designed to retain a scrubbing apparatus and be plunged into hollow vessel 110 during use. Pumping apparatus 150 may include a pole portion 152 and a handle portion 160, as shown, for example, in FIG. 11. In an exemplary embodiment, handle portion 160 and pole portion 152 may be made of rigid PVC piping. However, pumping apparatus 150 may also be made of other plastics, polymers, composites, metal, or wood. The handle portion 160 may extend generally perpendicular to pole portion 152 and may be attached at a top end of pole portion 152. Pumping apparatus 150 may contain at least one filter media 130. In some embodiments, the at least one filter media 130 is mounted within a filter housing 140, which is mounted on pole portion 152, as shown in FIG. 10, for example. In other embodiments, the at least one filter media 130 may be mounted directly on pole portion 152, as shown in FIG. 19, for example. The at least one filter media 130 disposed within pumping apparatus 150 may be shaped to substantially fill a cross-sectional area of hollow vessel 110. In an exemplary embodiment, there may be at least two filter media 130 disposed within pumping apparatus 150. The at least two filters media 130 may be spaced so as to allow a scrubbing article, such as a sponge or wash mitt, to be placed between the at least two filter media 130 when inserted in vessel 110.

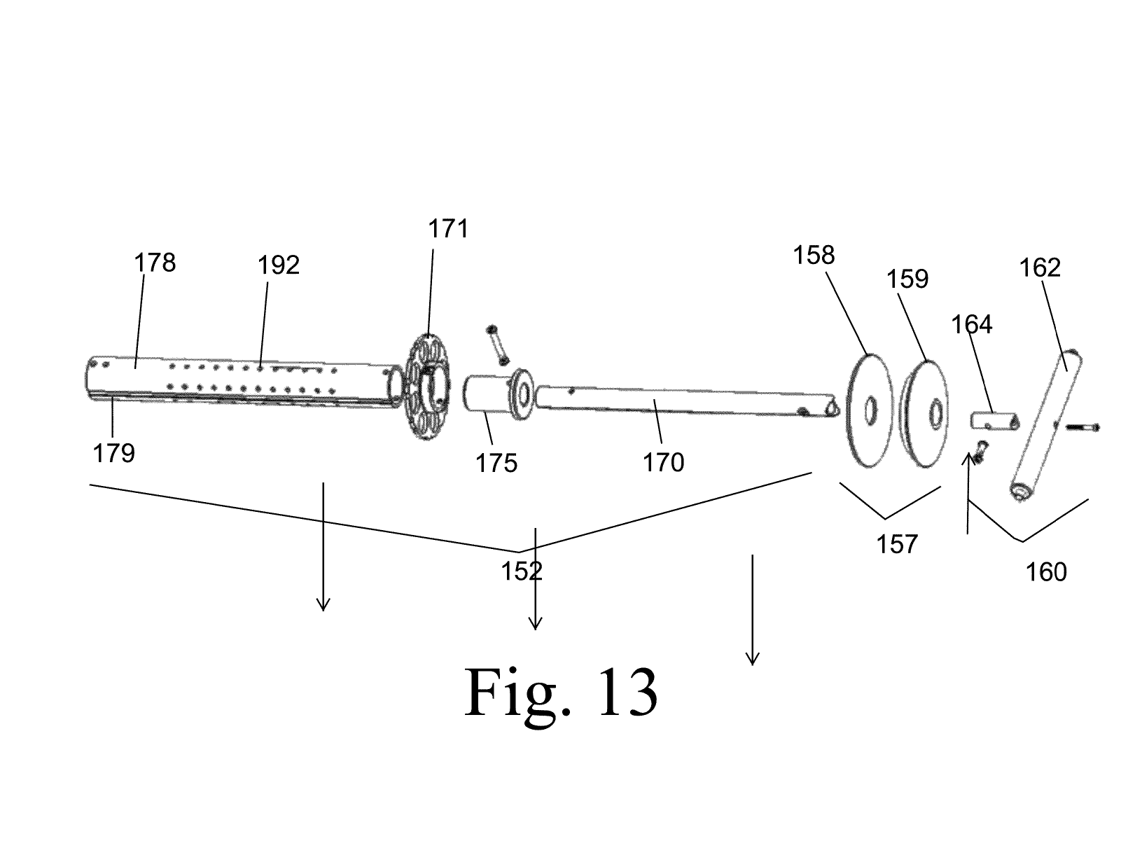

Embodiments of pumping apparatus 150 may be assembled out of ABS bar material or rigid PVC piping. The size of pumping apparatus 150 may vary to correspond with the size of vessel 110. In some exemplary embodiments, the diameter of the bar or piping may range from approximately 0.5 inches to approximately 12 inches. The handle portion 160 may have a cross member 162 and a joint 164 for connecting handle portion 160 to pole portion 152, as shown, for example, in FIG. 13. Cross member 162 may be sized and dimensioned to fit comfortably within a users hands and may be long enough to accommodate two hands. Cross member 162 may also be formed of a single length of ABS bar stock, which may be ½ inch to 2 inches in diameter and in some embodiments is approximately 1 inch in diameter. Cross member 162 may also be sized and dimensioned to fit within funnel or flute 125 during periods of non-use, as described above. In some embodiments, cross member 162 may include one or more protrusions 161, which may be located at one or more ends of cross member 162 and may be sized so as to cooperate with slot or partial ring 129.

Handle portion 160 may also have a joint 164 for connecting handle portion 160 to pole portion 152 as shown, for example, in FIG. 13. In some embodiments, cross member 162 may be one piece of material, such as an ABS bar, that is joined perpendicularly to an end of pole portion 152. The ABS bar may be ½ inch to 2 inches in diameter and in some embodiments is approximately 1 inch in diameter. Joint 164 may have a threaded hole at the top end for receiving a screw for attaching joint 164 to cross member 162. Joint 164 may also have a threaded hole along its length for receiving a screw to attach joint 164 to pole portion 152. In some embodiments, cross member 162 and pole portion 152 may be formed integrally, without the need for a joint.

In other embodiments, joint 164 may be a ¾ inch PVC tee with a ½ inch connector, as shown in FIG. 19. In such embodiments, cross member 162 may be two 6 inch long pieces of ¾ inch PVC pipe disposed on opposite ends of a PVC tee. There may be PVC end caps on the open ends of cross member 162. A top end 156 of pole portion may begin where pole portion 152 and handle portion 160 meet. Joint 164 and pole portion 152 may be connected by using a small piece of ½ inch PVC pipe 166 to connect a ½ inch PVC union joint 168. Alternatively, a 1½ inch PVC female coupler may be joined to the end of the pipe. The connections may be secured by threading the pipe ends or by using pipe with pre-threaded ends. A first segment 170 of ½ inch PVC pipe may then extend between approximately 8 inches and approximately 18 inches from the joint 168.

In some embodiments, the handle portion 160 connects to pole portion 152 at the top end of segment 170. In one exemplary embodiment, the segment 170 may be approximately 13 inches long and may have an outside diameter of ½ inch to 4 inches. In some embodiments, the outside diameter of segment 170 is about 1 inch. Segment 170 may be formed of a rigid PVC pipe or other suitable material. In some embodiments, segment 170 may have a threaded hole near the top end for fastening segment 170 to joint 164, as shown in FIG. 13, for example. Segment 170 may also have a threaded hole near its lower end for fastening segment 170 to a collar 175.

Collar 175 may be a flanged ABS tube that couples with the lower end of segment 170, as shown in FIG. 13. The lower end of segment 170 may be inserted into the upper, flanged opening of collar 175. The upper, flanged opening of collar 175 may have an internal diameter that may be the same as the outside diameter of segment 170 to allow collar 175 to receive segment 170. In some embodiments, the internal diameter of collar 175 may be somewhat larger than the outside diameter of segment 170 to allow for the application of one or more adhesives to collar 175 and/or the lower end of segment 170 prior to permanent coupling. Collar 175 may have one or more threaded holes below the flange in order to allow collar 175 to be attached to segment 170, perforated top disk 171, and perforated tube 178, as shown in FIG. 13.

Perforated top disk 171 may be a flanged ABS disk with a circular opening at the center of the disk and several smaller circular openings around the periphery of the disk, as shown in FIG. 13, for example. The internal diameter of the circular opening of perforated top disk 171 may match the external diameter of perforated tube 178 so that perforated tube 178 may be inserted therethrough. The upper, cylindrical portion of perforated top disk 171 may include one or more holes for receiving a screw that may attach perforated top disk 171 to collar 175 and perforated tube 178. When collar 175 is inserted into perforated top disk 171, the upper, cylindrical portion of perforated top disk 171 abuts the lower surface of the flanged portion of collar 175. The circular openings around the periphery of perforated top disk 171 allow water to traverse the disk when the pumping apparatus 150 is in operation. Perforated top disk 171 may also include one or more notches around the circumference of the disk that also allow water to traverse the disk when the pumping apparatus 150 is in operation.

Perforated top disk 171 may also be formed with a keying feature in order to ensure that it aligns properly with perforated tube 178 during coupling. The keying feature may employ any suitable means for forcing perforated tube 178 and perforated top disk 171 to properly align. In some embodiments, internal surface of the circular opening at the center of perforated top disk 171 may be formed with one or more protrusions 173 that correspond to one or more grooves or notches 179 that may be formed along the length of perforated tube 178, as shown in FIG. 13, for example. During coupling, the one or more protrusions 173 may fit into the one or more grooves 179, ensuring that the perforated top disk 171 is properly aligned with the perforated tube 178. Perforated bottom disk 177, which is further described below, may have substantially the same design and construction as perforated top disk 171, except that it is attached to the bottom of perforated tube 178 and perforated ribbed disk bottom 148 and is therefore a mirror image of perforated top disk 171, as shown in FIGS. 10 and 11, for example.

Perforated tube 178 may be a rigid PVC pipe between approximately 6 and approximately 12 inches long. More particularly, perforated tube 178 may be approximately 8 inches long. The outside diameter of perforated tube 178 may be between ½ to 2½ inches and may be about 1½ inches. The inside diameter of perforated tub 178 may be between 1 to 3 inches and, in some embodiments, may be about 2 inches. The internal diameter should be sized to match the outside diameter of collar 175, to allow collar 175 to be inserted into perforated tube 178, as shown in FIG. 13, for example. Holes 192 may be drilled in perforated tube 178, allowing water stopped by collar 175 to escape perforated tube 178. The holes 192 may be approximately 1/16th of an inch in diameter. In one exemplary embodiment, there may be approximately 12 holes in a line with approximately 1.2 inch spacing. In other embodiments, there may be any desired number of holes disposed in perforated tube 178. Holes 192 may be in a line along the longitudinal axis of perforated tube 178, or holes 192 may be disposed around perforated tube 178. The streams of water ejected from the holes 192 during pumping may contact a scrubbing article, dislodging dirt and grit. Holes 192 may further add to the mixing of wash solution in the water and in some embodiments may assist in creating bubbles and suds. Perforated tube 178 may further be formed with one or more grooves 179 that correspond to one or more protrusions 173 that may be formed along within perforated top disk 171. During coupling, the one or more protrusions 173 may fit into the one or more grooves 179, ensuring that the perforated top disk 171 and perforated tube 178 are properly aligned. Perforated tube 178 may also include one or more threaded holes near its top end for fastening the perforated tube 178 to collar 175 and perforated top disk 171 with a screw. Perforated tube 178 may also include one or more threaded holes near its lower end for fastening perforated tube 178 to perforated bottom disk 177.

In some embodiments, collar 175 and perforated top disk 171 allow for the mounting of filter housing 140 on pole portion 152. In a simplified embodiment, filter housing 140 may not be used and collar 175 and perforated top disk 171 may not be necessary. In such alternate embodiments, a half inch PVC coupler 172 may be joined to the open end of segment 170 instead of a collar 175, as shown in FIG. 19, for example. A second segment 174 of ½ inch PVC pipe may then be attached to the open side of PVC coupler 172. Segment 174 may be between approximately 1 and 2 inches in length. More particularly, segment 174 may be approximately 1.25 inches. Segment 174 may hold a first filter module 132 disposed around it. First filter module 132 may capture particles from the water and may keep a scrubbing article in a desired area within vessel 110. The connections below coupler 172 may be separable so as to remove, replace, or wash filter media 130. Alternatively, non-permanent couplings may include screw-fit couplings, PVC compression couplings, or securing a pipe within a coupling by drilling a hole through the connection and putting a removable pin, screw, or bolt through the connection to secure the pieces. Coupler 176 may be disposed on the end of segment 174 opposite coupler 172. In an exemplary embodiment, all of the segments may be threaded or pre-threaded on one or more ends to secure in corresponding threaded female couplers. However, threaded connections are not required.

In some embodiments, pole portion 152 may include a cap assembly 157, as shown, for example, in FIG. 13. Cap assembly 157 may located along pole portion 152 and may rest on open top end 112 of hollow vessel 110 when pumping apparatus 150 is in operation. Cap assembly 157 is intended to prevent splashing and to retain soapy water within hollow vessel 110. Cap assembly 157 may comprise any material capable of being installed on pole portion 152 and substantially covering open top end 112 such as silicone rubber and/or ABS plastic. In some embodiments, cap assembly 157 may have a circular opening at its center and may be installed on pole portion 152 by inserting pole portion 152 through the hole in cap assembly 157 before collar 175 is installed. In other embodiments, cap assembly 157 may be installed on pole portion 152 by sliding pole portion 152 through a slit or opening in cap assembly 157. In some embodiments, cap assembly 157 may not be fastened to pole portion 152, but rather may be allowed to slide freely up and down pole portion 152 when pumping apparatus 150 is in use. In some embodiments, cap assembly 157 may further comprise two or more circular disks, which may further comprise a silicone rubber disk 158 and/or an ABS plastic cap 159, as shown, for example, in FIG. 13.

In some embodiments, a plug 190 may be disposed within pipe portion 152 in order to prevent water flow through pipe portion 152 beyond a certain point, as shown in FIG. 19. Plug 190 may be located in segment 174 or coupler 176 or any other portion above segment 174. Below coupler 176 there may be a perforated tube 178 of 1/2 PVC pipe between approximately 6 and approximately 12 inches long, as previously described. A ½ inch PVC coupler 180 may then be removably connected to the open end of perforated tube 178. A segment of ½ inch PVC pipe 182 between approximately 1 and approximately 2 inches may be inserted into the open side of PVC coupler 180. More particularly, segment 182 may be approximately 1.25 inches and may hold a second filter module 134 disposed around it. Second filter module 134 may capture particles in the water and keep a scrubbing article in a desired area within vessel 110. Another coupler 184 and segment 186 may follow segment 182. A bottom end of pole portion 152 may be a last coupler 188. Couplers 184, 188 and segment 186 may form a third filter module area. Segment 186 may be between approximately 1 and approximately 2 inches in length, more particularly approximately 1.75 inches in length.

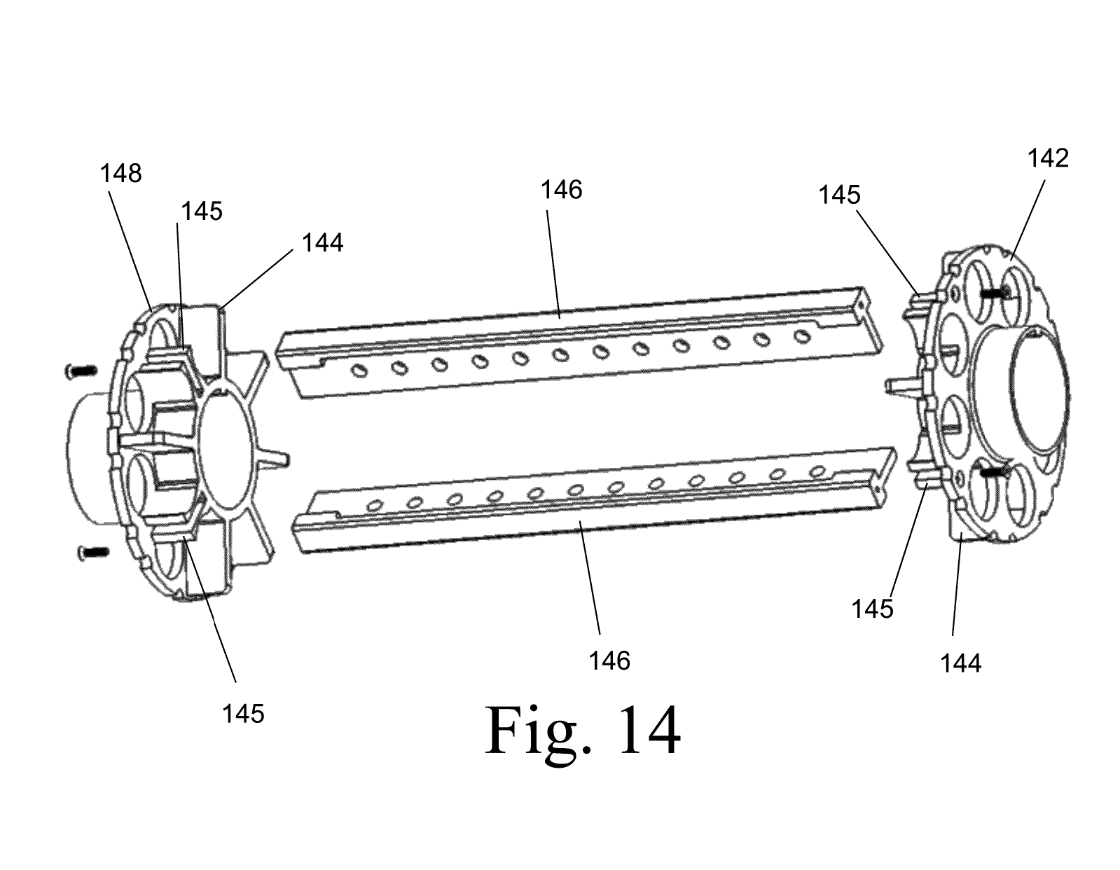

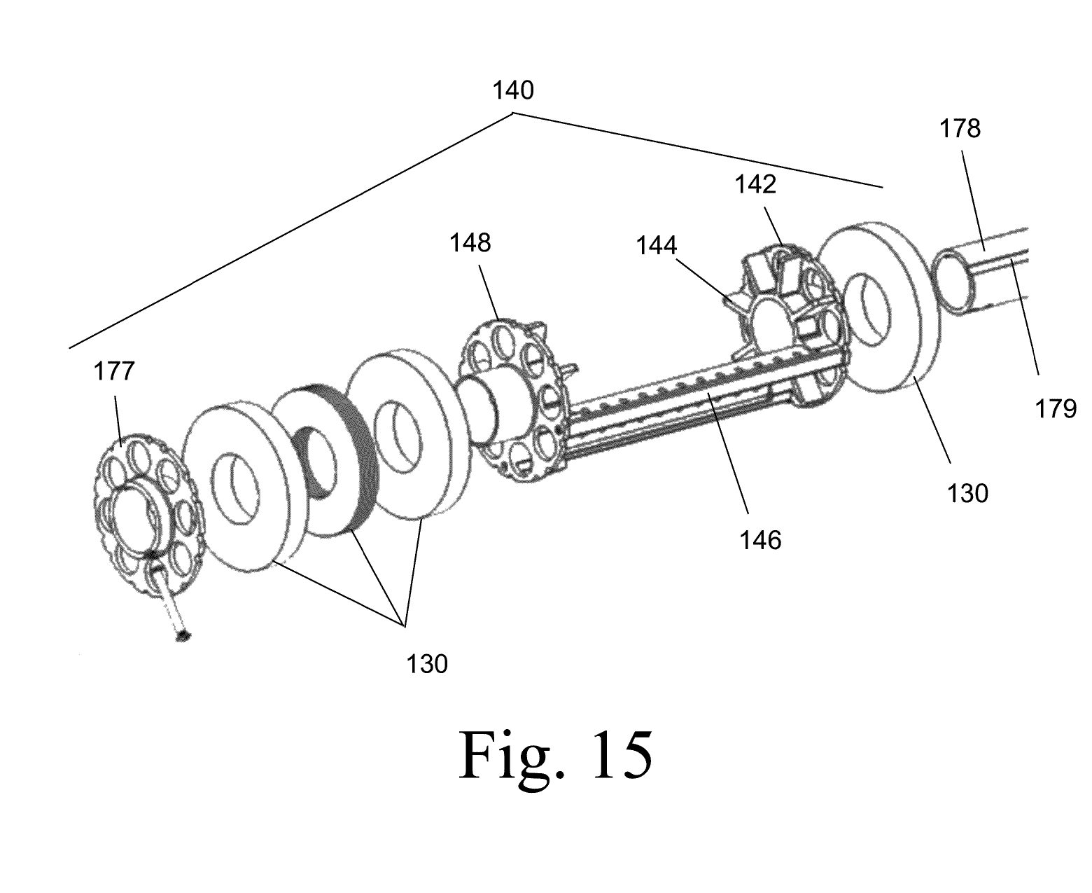

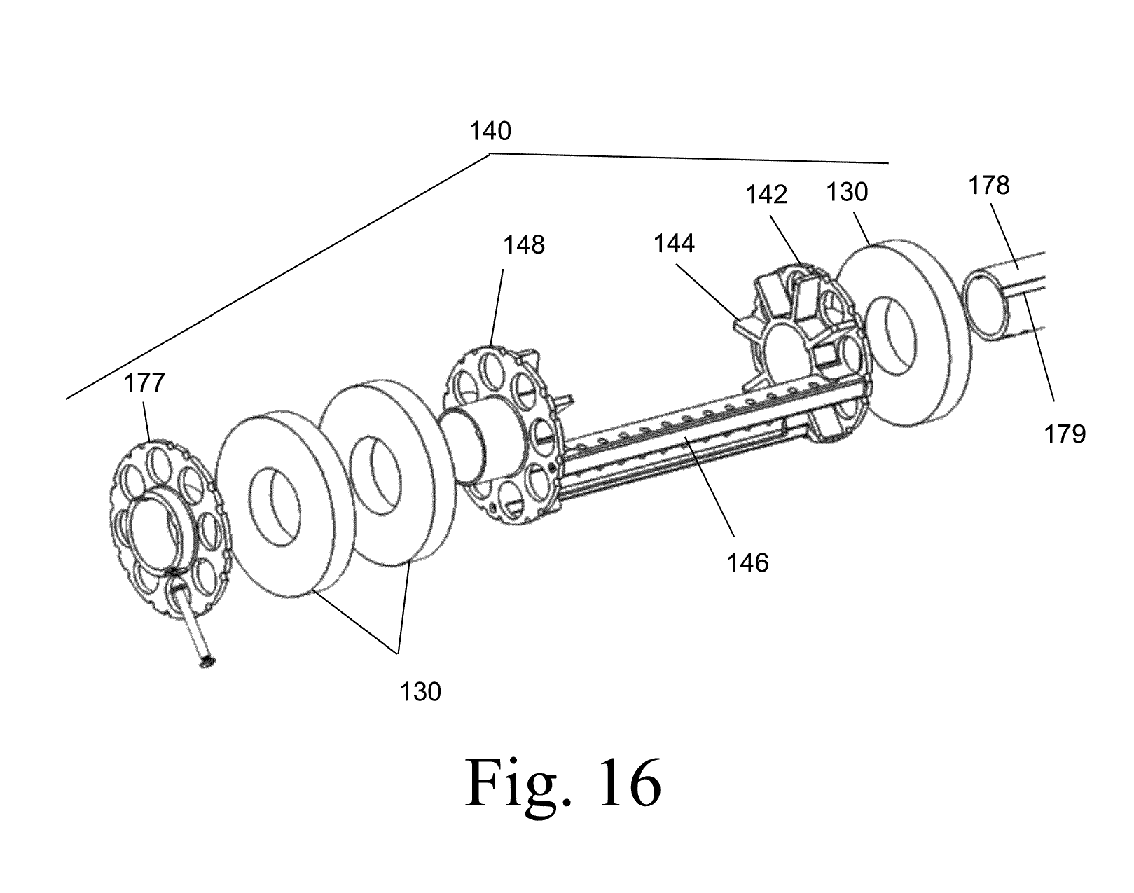

In some embodiments, a filter housing 140 may be used to mount filter media 130 on pole portion 152, as shown FIGS. 11 and 15, for example. In such embodiments, filter modules 132 may not be necessary, and filter media 130 may be mounted on pole portion 152 without the need for the aforementioned substantially rigid grates which form part of the filter modules 132. A filter housing 140 may include an internal disk assembly 141 that may have a perforated ribbed disk top 142 and a perforated ribbed disk bottom 148. Perforated ribbed disk top 142 may be a flanged ABS disk with a circular opening at the center of the disk and several smaller circular openings around the periphery of the disk, as shown in FIGS. 15 and 16, for example. The top of perforated ribbed disk top 142 may include a cylindrical portion, upon which one or more filter media 130 may be mounted, as shown, for example, in FIG. 14. The internal diameter of the circular opening of perforated ribbed disk top 142 may match the external diameter of perforated tube 178 so that perforated tube 178 may pass therethrough. The circular openings around the exterior of perforated ribbed disk top 142 allow water to traverse the disk when the pumping apparatus 150 is in operation. Perforated ribbed disk top 142 may also include one or more notches around the circumference of the disk that also allow water to traverse the disk when pumping apparatus 150 is actuated.

Perforated ribbed disk top 142 may also be formed with a keying feature in order to ensure that it aligns properly with perforated tube 178 during insertion. The keying feature may employ any suitable means for forcing perforated tube 178 and perforated top disk 171 to properly align. In some embodiments, the internal surface of the circular opening at the center of perforated ribbed disk top 142 may be formed with one or more protrusions 143 that correspond to one or more grooves 179 that may be formed along perforated tube 178. When perforated tube 178 is inserted into filter housing 140 the one or more protrusions 143 may fit into the one or more grooves 179, ensuring that the filter housing 140 is properly aligned with the perforated tube 178.

The underside of perforated ribbed disk top 142 may include one or more projections or ribs 144, which may be arranged around the center opening and project outward to the edge of perforated ribbed disk top 142, as shown in FIG. 16, for example. The one or more projections or ribs 144 maintain space between the scrubbing article and the filters during operation of pumping apparatus 150, allowing water to flow more freely through the filter media 130. Any number of the one or more projections or ribs 144 may be used on the underside of perforated ribbed disk top 142. Where multiple ribs are employed, they may be equally spaced around the underside of perforated ribbed disk top 142. In some embodiments eight projections or ribs 144 may be used.

The underside of perforated ribbed disk top 142 may also include one or more brackets 145 for holding one or more baffles 146 in place between perforated ribbed disk top 142 and perforated ribbed disk bottom 148, as shown in FIG. 14, for example. Brackets 145 may project perpendicularly from the underside of perforated ribbed disk top 142 and may comprise two parallel ribs that together form a slot for receiving one or more baffles 146. Baffles 146 may be fastened to brackets 145 using a screw through a threaded hole that extends through perforated ribbed disk top 142 and the top of baffles 146, as shown in FIG. 14, for example. In some embodiments adhesive may also be applied to brackets 145 before inserting baffles 146. Perforated ribbed disk bottom 148 may have substantially the same design and construction as perforated ribbed disk top 142, except that it is attached to the bottom of baffles 146 and is therefore a minor image of perforated ribbed disk top 142, as shown in FIG. 14, for example.

One or more baffles 146 may also extend between perforated ribbed disk bottom 148 and perforated ribbed disk top 142. Baffles 146 may help retain a scrubbing article in a generally upright manner and restrict the lateral movement of the scrubbing article when pumping apparatus 150 is in use. Baffles 146 may comprise a T-bar formed of ABS material. The T-bar shape may allow the baffle 146 to fit into the slot formed by brackets 145 at its lower portion, while abutting brackets 145 at its upper portion, as shown in FIG. 14, for example. The lower portion of baffles 146 may also be perforated, allowing for increased water flow around and through baffles 146 when pumping apparatus 150 is actuated. Filter housing 140 may include any number of baffles 146 and multiple baffles may provide for additional locations for placing and washing multiple scrubbing articles. In some embodiments, Filter housing 140 may include two baffles defining a single location for placing and washing scrubbing articles.

Filter housing 140 may hold one or more filter media 130 in place when pumping apparatus 150 is in operation. One or more filter media 130 may be arranged on the cylindrical projection on the top of perforated ribbed disk top 142 and/or on the cylindrical projection on the bottom of perforated ribbed disk bottom 148, as shown, for example, in FIGS. 10 and 11. Any filters arranged at the top of perforated ribbed disk top 142 may be held in place with perforated top disk 171. In some embodiments, perforated ribbed disk top 142 may be fastened to perforated top disk 171 using a screw. In other embodiments, perforated ribbed disk top 142 may be held in place against perforated top disk 171 by the force exerted by perforated bottom disk 177, which may be fastened to perforated ribbed disk bottom 148 and/or perforated tube 178 at the bottom of perforated tube 178. Perforated bottom disk 177 may be fastened using a screw, as shown in FIG. 11, for example. Any filters arranged at the bottom of perforated ribbed disk bottom 148 may similarly be held in place by perforated ribbed disk bottom 148, which may be fastened to perforated tube 178 and/or perforated ribbed disk bottom 148 at the bottom of perforated tube 178, using a screw, as shown in FIG. 11.

Filter media 130 may be generally circular with an external diameter that matches the internal diameter of hollow vessel 110. The center of filter media 130 may also include a circular hole so that filter media 130 may be mounted on the cylindrical portion of perforated top disk 171 and/or perforated bottom disk 177. The internal diameter of the circular hole at the center of filter media 130 may match the external dimension of the cylindrical portions of perforated top disk 171 and perforated bottom disk 177 to allow for mounting filter media 130 thereon. Alternatively, the internal diameter of the circular hole at the center of filter media 130 may match the outside diameter of perforated tube 178 so that they may be directly mounted thereon. The size and shape of filter media 130 may correspond to the size and shape of hollow vessel 110, perforated top disk 171, perforated bottom disk 177, or perforated tube 178, for different embodiments.

Filter media 130 may be formed of any filter media suitable for filtering dirt and other contaminants from soapy water. In some embodiments, filter media 130 may be formed of filter foam or filter pads, as shown, for example, in FIGS. 10 and 11. In some embodiments, filter media 130 may be formed of different filter media in combination with one another. Filter media 130 may include various filter materials based on differing situations. For example, a user may desire a different filter material based on the type of dirt, gravel, snow, salt, etc. that the vehicle may have contacted. Exemplary filter materials may include plastic grids or grates, micron rated felt filter material, and thin film composites. Filter media 130 may include a variety of alternative filter materials including but not limited to polyester, polypropylene, aramid, nylon, rayon, viscose, polyether, and acrylic. The materials may be in sheet form, or the filter material may also be pleated, stringwound, polyspun, or comparably formed to function as substantially as described.

In some embodiments filter media 130 may be mounted directly onto pumping apparatus 150 without the use of filter housing 140, as shown, for example, in FIGS. 19-22. In such embodiments, it may be necessary to enclose filter media 130 within a filter module 132. In an exemplary filter module, a plastic grid material may be disposed around layers of micron felt material. The plastic grid material may provide rigidity to the filter media 130, preventing the modules from bending under the pressure and force applied when pumping through the water. The plastic grid material may not only trap coarse particles, but it may also come in contact with the scrubbing article that is being washed, loosening dirt and grime from the material of the scrubbing article. The grid material maybe plastic hardware cloth with 0.5 inch grates. An alternative embodiment may include plastic discs with holes disposed through them. More particularly the plastic discs may be cut to approximately a four inch diameter and may have 0.25 inch holes drilled in them. The holes may allow water to flow through the discs, while still providing rigidity to the filter module.

The layers of micron felt filter material may vary in coarseness. The layers may be arranged so the coarsest layer is proximate a scrubbing article disposed between the first and second filter modules. This may allow for a wider size range of particles to become trapped in the filter. The coarse particles are trapped in the early layers and finer particles that are able to travel through the coarse filters are trapped by the deeper, fine filter layers. In an exemplary embodiment, the filter sheets may be ordered so that from the sheet closest to the scrubbing article wash area 124 to the furthest, the individual sheet micron ratings go 100, 50, 25, 10, 5, 1. Therefore in filter module 132 the sheets' ratings may go from top to bottom: 1, 5, 10, 25, 50, 100. In filter module 134 the sheets' ratings may go from top to bottom: 100, 50, 25, 10, 5, 1. In addition to the micron rated felt filter sheets, a layer of coarse filter material may be disposed closest to the scrubbing article wash area 124. In an exemplary embodiment, the coarse filter material may be approximately 1 inch thick. If the filter material were layered with the finest layers adjacent the scrubbing article wash area 124, the coarse particles may remain loose in the wash solution because the coarse particles may be too large to become entangled in or pass through the finer filter layers to reach the coarse layers.

The micron rated felt filter layers and the layer of coarse filter material may be bound together so that the material does not bend with the movement and pressure created by the churning water. The filter materials may be bound by monofilament line sewn throughout the filter module or the materials may be bound with an ultrasonic weld. The rigidity of the filter module may allow it to more effectively filter the water. The plastic grid layer on the top and bottom of each filter may also add rigidity to the filter modules. The third and fourth filter modules 136, 138 may include similar plastic grids enclosing layers of filter material. In an exemplary embodiment, the third filter module may have six sheets of micron rated felt filter material ordered from largest micron ratings on top to smallest on bottom. The fourth filter module, which may be disposed immediately below the third, may have six sheets of micron rated felt filter material ordered from smallest micron ratings on top to largest on bottom. This setup may allow for trapping various size particles. Since the third and fourth filter modules do not have a wash area or water between them, the outer layers are the coarsest and the inner layers are the finest filter layers. If the filter material were layered with the outer layers being the finest, the coarse particles may remain loose in the wash solution because the coarse particles may be too large to become entangled in or pass through the finer filter layers to reach the coarse layers. In an exemplary embodiment, the third and fourth modules may not have an additional layer of coarse filter material, though this may not be true for all embodiments. Similar to the first and second filter modules, the filter material of the third and fourth filter modules may be sewn together. They may be sewn together by monofilament line or similar material as would be understood by a person having ordinary skill in the art. They may also be bonded together by ultrasonic welding. The third and fourth filter modules may trap particles that escaped the first and second modules or that had settled in the bottom of hollow vessel 110.

The filter modules 132 may be placed on pole portion 152 by cutting an incision through the filter modules and sliding them onto the desired segment of pole portion 152. In an exemplary embodiment, the incisions may be approximately ¾0 inches in length and may be located approximately 1.5 cm offset from the center of the filter module. In an exemplary embodiment, the incisions may result in a crown effect on the felt material. The crowns may be used to ensure the filter modules are loaded in the appropriate orientation. The crowns may bunch together preventing the module from cleaning loading on the pole portion 152. In an exemplary embodiment, the crowns may be aligned so they are pointing to the top of the pumping apparatus 150. Alternatively, filter module 138 may have a circular hole at the center that allows filter module 138 to be mounted on pole portion 152 by temporarily disconnecting segments of pole portion 152, mounting one or more filter modules 138, and reconnecting the necessary segments of pole portion 152.

In some exemplary embodiments, various segments of pumping apparatus 150 may be added, modified, or removed to produce desired effects. For example, segments with propellers or other water flow enhancers may be included along pole portion 152. In one alternative embodiment, perforated tube 178 may have a different spray design from what was described above. For example, a replacement perforated tube 178 may have slices for producing a different desired stream of water. A replacement perforated tube 178 may alternatively have holes disposed in a helical pattern. Even further, a replacement segment may have a device that is moveable by the force of the water and that may change the orientation of a scrubbing article disposed in the scrubbing article wash area 124 so as to expose all surfaces of the article to water flow and the filter modules. It should be appreciated that various segments of pumping apparatus 150 may be added, modified, or removed.

While exemplary embodiments described above may have utilized specific materials and dimensions, such as four inch PVC pipe, they should not be read as limiting. Embodiments referenced throughout the detailed description may be made from a variety of materials including other plastics, polymers, rubbers, or composites. More specifically, materials may include Acetal, Polypropylene, High Density Polyethylene (HDPE), Polycarbonate, Acrylonitrile Butadiene Styrene (ABS), Polycarbonate/ABS Alloy, Polybutylene Terephthalate, Polybutylene, and Polyethylene Terephthalate, glass-filled Acrylic. Metals may also be used, though the use of metals may cause undesired chemical reactions with water and cleaning solutions. The various parts may also be sized appropriately to wash a desired article within the washing area.

In operation, an exemplary embodiment of a scrubbing article cleaning device may function substantially as follows. A user may fill a hollow vessel 110 with water, soap and water, or a desired cleaning solution. The user may fill the hollow vessel to a designated fill line 122 or to a desired level. The user may then insert a pumping apparatus 150 into the hollow vessel such that the filter media 130 disposed on the pumping apparatus are submerged in the liquid filling the hollow vessel. Alternatively, the user may fill the hollow vessel when the pumping apparatus 150 has already been inserted. If the liquid needs to be disturbed for any reason including to mix the solution or to create suds, the user may pump the pumping apparatus 150 up and down to do so. A user may then lift the pumping device out of the hollow vessel far enough so that the user may insert a scrubbing article inside the hollow vessel. In some embodiments, the scrubbing article will be placed within the filter housing 140 and, more particularly, may be placed between baffles 146 and between perforated ribbed disk top 142 and perforated ribbed disk bottom 148. In other embodiments, the scrubbing article may be placed between at least two of the filter media 130 disposed on the pumping device. This placement may keep the scrubbing article within a space defined by the sidewall of the hollow vessel 110, and by a filter media 130 of the pumping device on the top and bottom. Baffles 146, perforated ribbed disk top 142, and perforated ribbed disk bottom 148, may also serve to confine the movement of the scrubbing article, maintaining it in a more vertical position. Once a scrubbing article has been inserted, the user may pump the pumping device in a manner allowing the scrubbing article to move through the liquid and interact with the filter media, cleaning the scrubbing article of dirt and grit. Pressure may be generated by the downward force of the filter modules against the sides of the vessel. This pressure may force water through the perforations in perforated pipe 178 and the scrubbing article, freeing abrasive particles and grit from the scrubbing articles and forcing them into the surrounding filter media, which may trap them. As the device is pumped, bubbles and suds may be generated from the washing solution. The scrubbing article may be removed from the vessel after a desired period and used to wash a surface, such as a vehicle. If bubbles and suds are generated during the pumping process, they may transfer on the scrubbing article and eventually to the surface to be cleaned by the scrubbing article. The bubbles and suds may aid in lifting dirt from the surface to be cleaned, improving the effectiveness of the scrubbing article and washing process. The process for cleaning the scrubbing article and preparing it for further use may be repeated as desired.

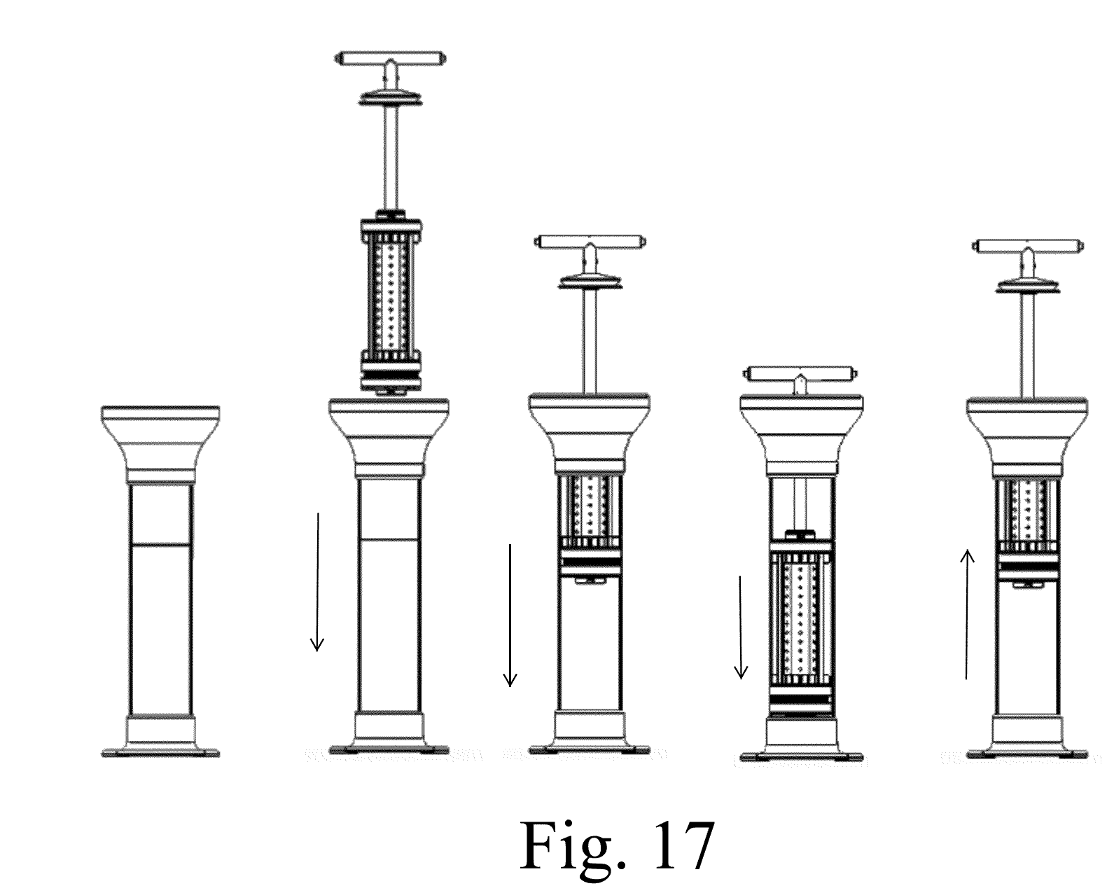

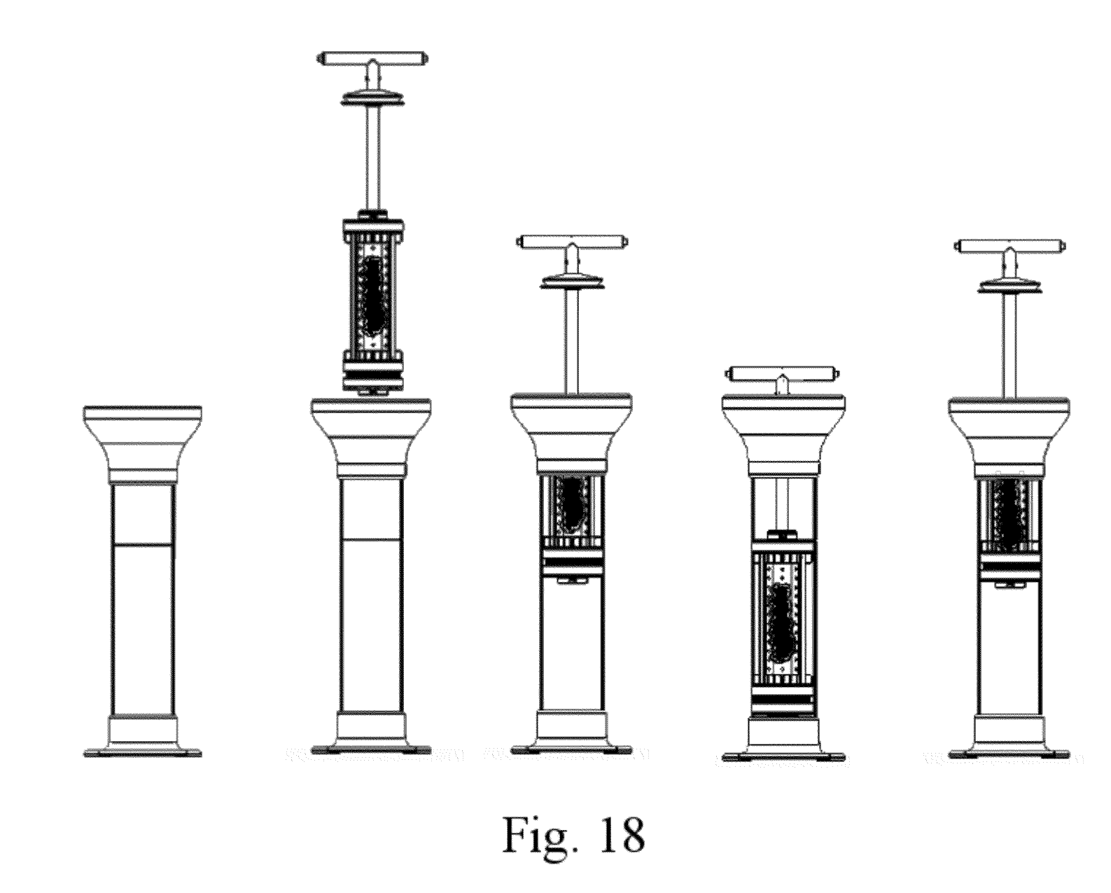

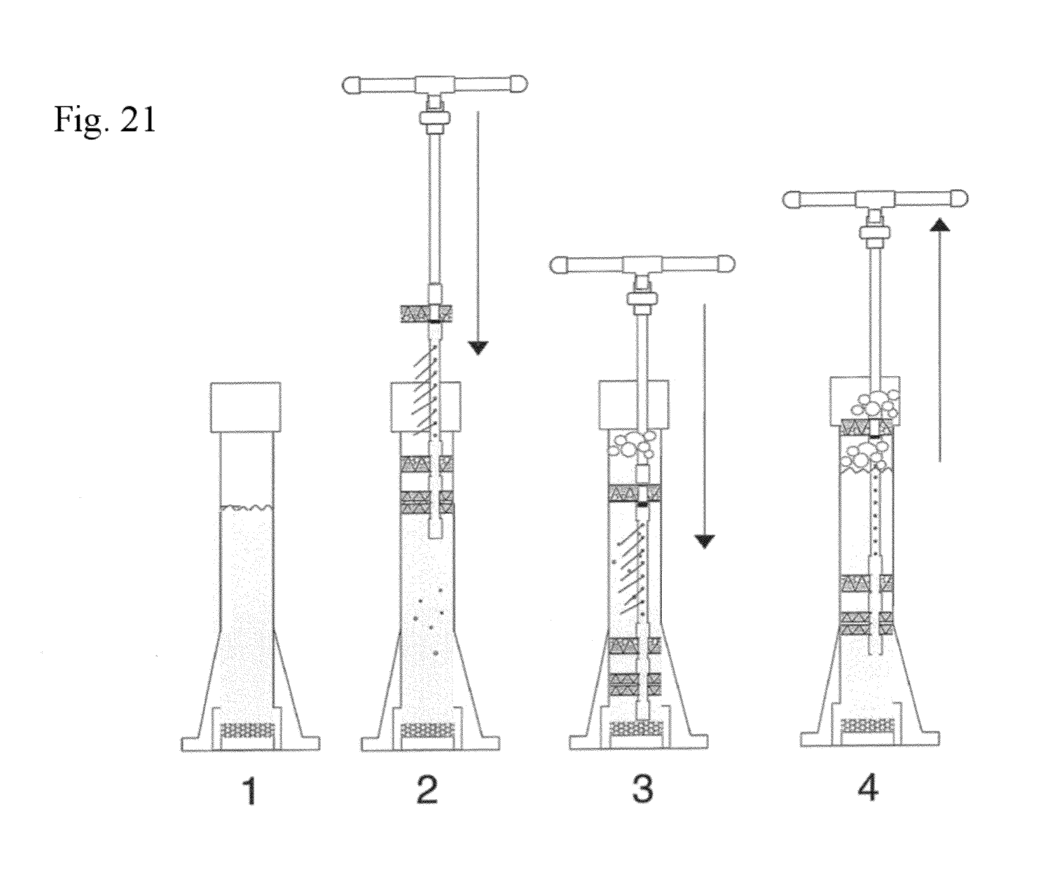

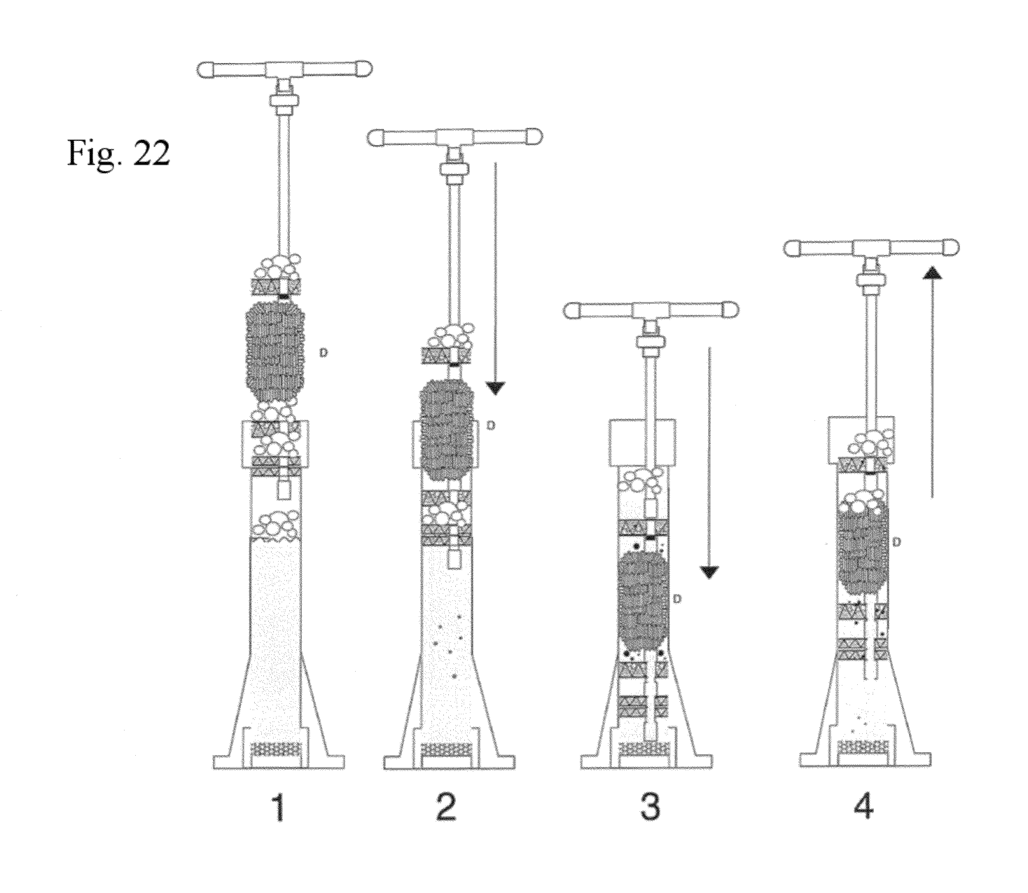

FIGS. 17-18 and 21-22 may substantially depict the operation of exemplary embodiments of a scrubbing article washing device, as described above. FIGS. 17 and 21 may show in series how the pumping apparatus may be inserted and pumped within the vessel in accordance with embodiments of the invention. FIGS. 18 and 22 may show the operation with a scrubbing article disposed within the device in accordance with embodiments of the invention.

The foregoing description and accompanying figures illustrate the principles, preferred embodiments, and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A scrubbing article cleaning device comprising:
a hollow vessel capable of retaining liquid and having an open top;
a pump having a handle portion connected to a top end of a pole portion, wherein said pole portion includes at least one segment of perforated pipe;
a plunger assembly connected to said pole portion, wherein said plunger assembly further comprises, one or more perforated disks and one or more filter media.

2. A scrubbing article cleaning device according to claim 1, wherein said plunger assembly further comprises one or more baffles.

3. A scrubbing article cleaning device according to claim 1, wherein one or more of said perforated disks includes one or more ribs.

4. A scrubbing article cleaning device according to claim 1, further comprising a funnel portion connected to the hollow vessel.

5. A scrubbing article cleaning device according to claim 4, wherein the funnel portion includes a means for receiving and releasably holding said handle portion.

6. A scrubbing article cleaning device according to claim 5, wherein said means for receiving and releasably holding said handle portion comprises one or more slots, one or more partial rings, one or more latches, one or more clasps, or one or more fasteners.

7. A scrubbing article cleaning device according to claim 1, further comprising a means for aligning said pole portion with said one or more perforated disks.

8. A scrubbing article cleaning device according to claim 1, wherein said plunger assembly further comprises a first filter set comprising at least one filter media retained between a first perforated disk and a second perforated disk and a second filter set comprising at least one filter media between a third perforated disk and a fourth perforated disk.

9. A scrubbing article cleaning device having a plunger comprising:
one or more filter media containing one or more cutouts;
one or more first perforated disks having a flanged portion for receiving said cutouts of said one or more filter media;
one or more second perforated disks having an opening for cooperating with said flanged portion.

10. A scrubbing article cleaning device according to claim 9, wherein said one or more filter media are retained between said one or more first perforated disks and said one or more second perforated disks.

11. A scrubbing article cleaning device according to claim 10, wherein said one or more first perforated disks are attached, fastened, or connected, either directly or indirectly, to said one or more second perforated disks.

12. A scrubbing article cleaning device according to claim 11, wherein one or more of said first or second perforated disks include one or more ribs.

13. A scrubbing article cleaning device according to claim 12, wherein one or more of said first or second perforated disks include one or more notches around the edge or perimeter of said first or second perforated disks.

14. A scrubbing article cleaning device according to claim 13, wherein one or more of said first or second perforated disks include one or more brackets for receiving one or more baffles.

15. A scrubbing article cleaning device according to claim 14, further comprising one or more baffles connected to said one or more brackets.

16. A scrubbing article cleaning device according to claim 15, wherein said one or more baffles are perforated.

17. A scrubbing article cleaning device according to claim 16, wherein a pole passes through said cutout, said opening, and said flanged portion.

18. A scrubbing article cleaning device according to claim 17, wherein at least a portion of said pole is perforated.

19. A scrubbing article cleaning device according to claim 18, wherein said pole is connected to a handle portion.

20. A process for the manufacture of a scrubbing article cleaning device comprising:
mounting one or more filter media on a flanged portion of a first perforated disk;
mounting a second perforated disk on the flanged portion of said first perforated disk, such that the one or more filter media are located between said first and second perforated disks;
inserting a perforated pole through the one or more filter media, the first perforated disk, and the second perforated disk; and
attaching said perforated pole to at least one of said first or said second perforated disks.
